(19) United States
(12) Patent Application Publication
(10) Pub. No.: US 2026/0100735 A1
(43) Pub. Date: Apr. 9, 2026

(54) 8 TX PUSCH FALLBACK TO LESS TX PUSCH TRANSMISSIONS

(71) Applicant: QUALCOMM Incorporated, San Diego, CA (US)

(72) Inventors: Kexin XIAO, Shanghai (CN); Yi HUANG, San Diego, CA (US); Yu ZHANG, San Diego, CA (US); Wanshi CHEN, San Diego, CA (US)

(21) Appl. No.: 19/110,661

(22) PCT Filed: Oct. 17, 2022
(86) PCT No.: PCT/CN2022/125716

§ 371 Date: Mar. 11, 2025

(51) Int. Cl. H04B 7/0456

(52) U.S. Cl. CPC H04B 7/0456

(57) ABSTRACT

Example implementations include a method, apparatus and computer-readable medium of wireless communication by a user equipment, comprising receiving, from a network entity, an indication to reduce a number of antenna ports associated with uplink precoding. The implementations further include transmitting, to the network entity, a reference signal using the reduced number of antenna ports. The implementations further include receiving, from the network entity, a message indicating a Transmit Precoder Matrix Indicator (TPMI) associated with the reduced number of antenna ports.

### BACKGROUND

### Technical Field

The present disclosure generally relates to communication systems, and more particularly, to uplink transmissions.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard.

There exists a need for further improvements in 5G NR technology. These improvements may also be applicable to other multi-access technologies and the telecommunication standards that employ these technologies. For instance, improvements to efficiency and latency relating to mobility of user equipments (UEs) communicating with network entities are desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Certain aspects are directed to a method for wireless communication at a user equipment. In some examples, the method includes receiving, from a network entity, an indication to reduce a number of antenna ports associated with uplink precoding. Additionally, in some examples, the method further includes, transmitting, to the network entity, a reference signal using the reduced number of antenna ports. Additionally, in some examples, the method further includes, receiving, from the network entity, a message indicating a Transmit Precoder Matrix Indicator (TPMI) associated with the reduced number of antenna ports.

Certain aspects are directed to a method for wireless communication at a network entity. In some examples, the method includes transmitting, to a User Equipment (UE), an indication to reduce a number of antenna ports associated with uplink precoding. Additionally, in some examples, the method further includes, receiving, from the UE, a reference signal using the reduced number of antenna ports. Additionally, in some examples, the method further includes transmitting, to the UE, a message indicating a Transmit Precoder Matrix Indicator (TPMI) associated with the reduced number of antenna ports.

Certain aspects are directed to an apparatus configured for wireless communication, comprising a processor, a memory coupled with the processor, and instructions stored in the memory, when executed by the processor, cause the apparatus to receive, from a network entity, an indication to reduce a number of antenna ports associated with uplink precoding. In some examples, the instructions, when executed by the processor, further cause the apparatus to transmit, to the network entity, a reference signal using the reduced number of antenna ports. In some examples, the instructions, when executed by the processor, further cause the apparatus to receive, from the network entity, a message indicating a Transmit Precoder Matrix Indicator (TPMI) associated with the reduced number of antenna ports.

Certain aspects are directed to an apparatus configured for wireless communication, comprising a processor, a memory coupled with the processor, and instructions stored in the memory, when executed by the processor, cause the apparatus to transmit, to a User Equipment (UE), an indication to reduce a number of antenna ports associated with uplink precoding. In some examples, the instructions, when executed by the processor, further cause the apparatus to receive, from the UE, a reference signal using the reduced number of antenna ports. In some examples, the instructions, when executed by the processor, further cause transmit, to the UE, a message indicating a Transmit Precoder Matrix Indicator (TPMI) associated with the reduced number of antenna ports.

Certain aspects are directed to a non-transitory computer-readable medium having instructions stored thereon that, when executed by an apparatus, cause the apparatus to perform operations comprising receiving, from a network entity, an indication to reduce a number of antenna ports associated with uplink precoding. Additionally, in some examples, the operations include, transmitting, to the network entity, a reference signal using the reduced number of antenna ports. Additionally, in some examples, the operations include, receiving, from the network entity, a message indicating a Transmit Precoder Matrix Indicator (TPMI) associated with the reduced number of antenna ports.

Certain aspects are directed to a non-transitory computer-readable medium having instructions stored thereon that, when executed by an apparatus, cause the apparatus to perform operations comprising transmitting, to a User Equipment (UE), an indication to reduce a number of antenna ports associated with uplink precoding. Additionally, in some examples, the operations include, receiving, from the UE, a reference signal using the reduced number of antenna ports. Additionally, in some examples, the operations include transmitting, to the UE, a message indicating a Transmit Precoder Matrix Indicator (TPMI) associated with the reduced number of antenna ports.

Certain aspects are directed to an apparatus for wireless communication. In some examples, the apparatus includes means for receiving, from a network entity, an indication to reduce a number of antenna ports associated with uplink precoding. In some examples, the apparatus includes means for transmitting, to the network entity, a reference signal using the reduced number of antenna ports. In some examples, the apparatus includes means for receiving, from the network entity, a message indicating a Transmit Precoder Matrix Indicator (TPMI) associated with the reduced number of antenna ports.

Certain aspects are directed to an apparatus for wireless communication. In some examples, the apparatus includes means for transmitting, to a User Equipment (UE), an indication to reduce a number of antenna ports associated with uplink precoding. In some examples, the apparatus includes means for receiving, from the UE, a reference signal using the reduced number of antenna ports. In some examples, the apparatus includes means for transmitting, to the UE, a message indicating a Transmit Precoder Matrix Indicator (TPMI) associated with the reduced number of antenna ports.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1A is a diagram illustrating an example of a wireless communications system and an access network.

FIG. 1B is a diagram illustrating an example of disaggregated base station architecture, in accordance with various aspects of the present disclosure.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating an example of a call flow between a network entity and a UE, in accordance with various aspects of the present disclosure

FIG. 5 is a diagram illustrating an example of fallback signaling, in accordance with present disclosure.

FIG. 6 is a diagram illustrating an example of fallback signaling, in accordance with present disclosure.

FIG. 7 is a diagram illustrating an example of resources of a reference signal, in accordance with present disclosure.

FIG. 8 is a diagram illustrating an example of resources from multiple resource sets of a reference signal, in accordance with present disclosure.

FIG. 9 is a diagram illustrating an example of fallback signaling, in accordance with present disclosure.

FIG. 10 is a diagram illustrating an example of a resource of a reference signal, in accordance with present disclosure.

FIG. 11 is a diagram illustrating an example of a Transmit Precoder Matrix Indicator (TPMI) table.

FIG. 12 is a diagram illustrating an example of a hardware implementation for an example apparatus.

FIG. 13 is a flowchart of a method of wireless communication.

FIG. 14 is a flowchart of a method of wireless communication.

FIG. 15 is a flowchart of a method of wireless communication.

FIG. 16 is a flowchart of a method of wireless communication.

FIG. 17 is a flowchart of a method of wireless communication.

FIG. 18 is a flowchart of a method of wireless communication.

FIG. 19 is a flowchart of a method of wireless communication.

FIG. 20 is a flowchart of a method of wireless communication.

FIG. 21 is a flowchart of a method of wireless communication.

FIG. 22 is a flowchart of a method of wireless communication.

FIG. 23 is a flowchart of a method of wireless communication.

FIG. 24 is a diagram illustrating another example of a hardware implementation for another example apparatus.

FIG. 25 is a flowchart of a method of wireless communication.

FIG. 26 is a flowchart of a method of wireless communication.

FIG. 27 is a flowchart of a method of wireless communication.

FIG. 28 is a flowchart of a method of wireless communication.

FIG. 29 is a flowchart of a method of wireless communication.

FIG. 30 is a flowchart of a method of wireless communication.

FIG. 31 is a flowchart of a method of wireless communication.

FIG. 32 is a flowchart of a method of wireless communication.

FIG. 33 is a flowchart of a method of wireless communication.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

For uplink transmissions, a UE may be configured for codebook based uplink transmissions. In codebook based uplink transmissions, a network entity serving the UE may indicate a precoder codebook to the UE to apply for the UE's uplink transmissions. The precoder codebooks may be fully coherent, partial coherent, or non-coherent. For fully coherent precoder codebooks, both radio frequency (RF) and baseband of every antenna port of the UE is turned on. For partial and non-coherent codebooks, while baseband of some of the antenna ports can be turned off, RF for those antenna ports is still turned on. One of the reasons for this is that any of those antenna ports may be used in a next slot for uplink transmission (e.g., PUSCH). Therefore, the UE is configured to maintain these antenna ports in a stand-by mode by continuing to power on the RF for these antenna ports.

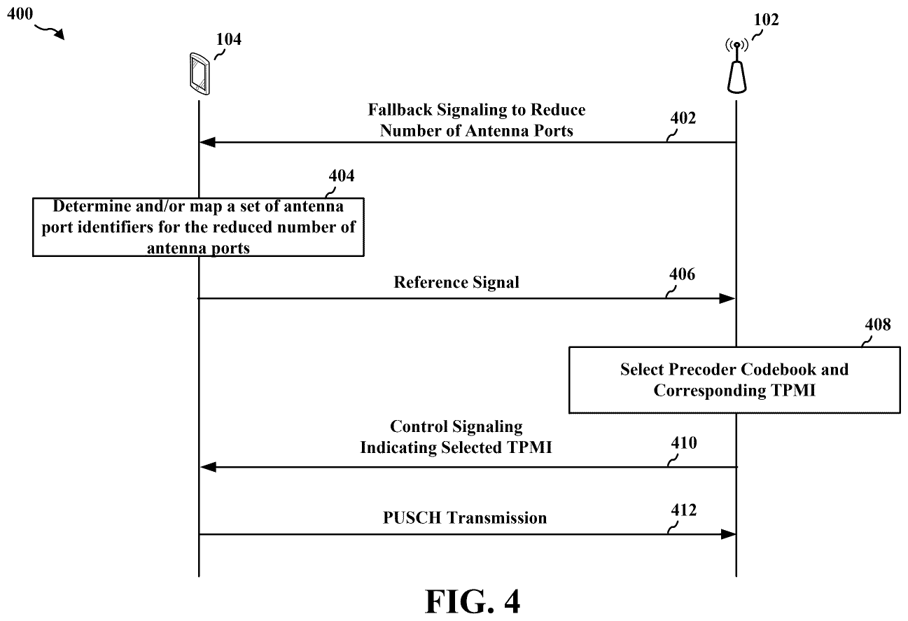

However, by continuing to have the RF of such antenna ports powered on, the UE is not efficiently saving power, and total power management of the UE may be suboptimal. Furthermore, inefficiencies of such power saving and power management are further exacerbated when the uplink traffic is low. Accordingly, the techniques described herein allow a UE to more efficiently save power when uplink traffic is low. Additional details of these techniques are described herein with respect to FIGS. 4-33.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

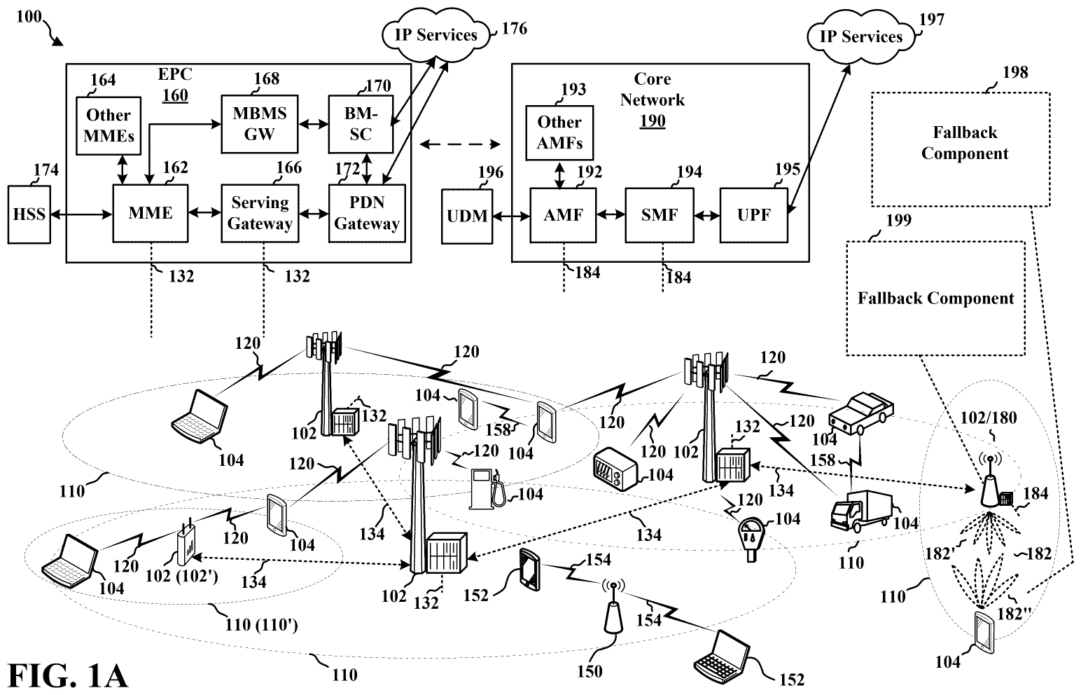

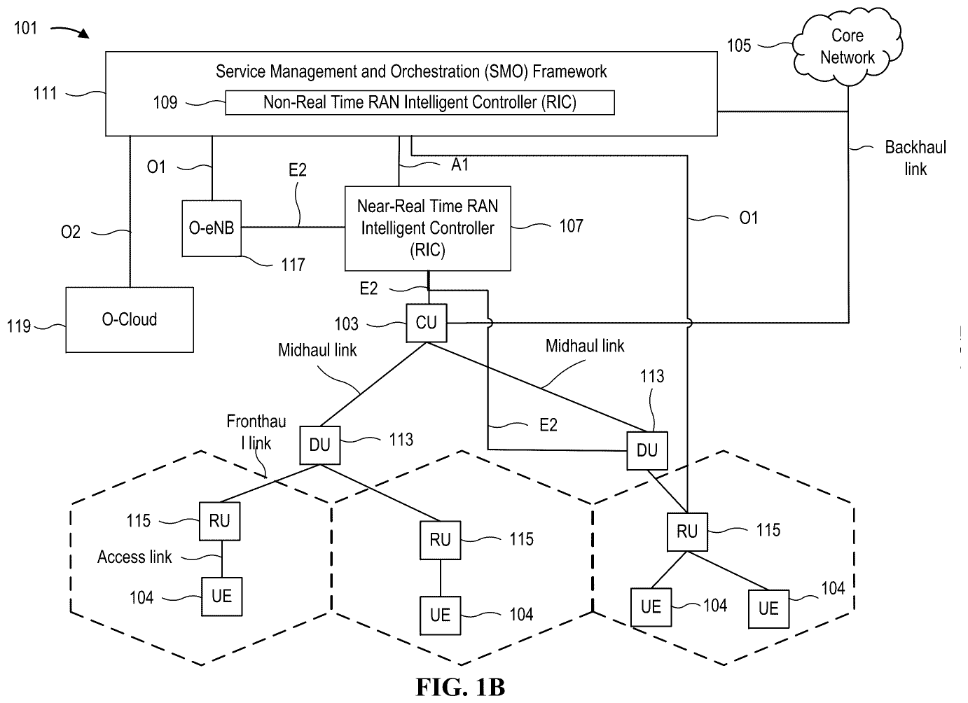

FIG. 1A is a diagram illustrating an example of a wireless communications system 100 (also referred to as a wireless wide area network (WWAN)) that includes base stations 102 (also referred to herein as network entities), user equipment(s) (UE) 104, an Evolved Packet Core (EPC) 160, and another core network 190 (e.g., a 5G Core (5GC)).

One or more of the UE 104 may include a fallback component 198, and one or more of the base stations 102 (e.g., network entities) may be configured to include a fallback component 199, wherein the fallback component 198 and the fallback component 199 are operable to reduce power consumption and/or increase power management efficiency of UE 104 and base stations 102 (e.g., network entities) respectively.

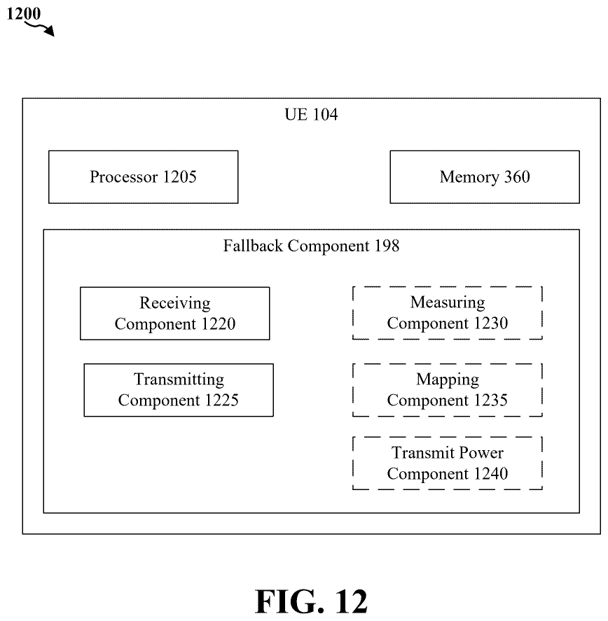

At one or more of the UEs 104, and additionally referring to FIG. 12, the fallback component 198 includes a receiving component 1220 configured to receive an indication to reduce a number of antenna ports associated with uplink precoding. Further, the fallback component 198 includes a transmitting component 1225 configured to transmit a reference signal using the reduced number of antenna port. Additionally, the receiving component 1220 may be configured to receive a message indicating a Transmit Precoder Matrix Indicator (TPMI) associated with the reduced number of antenna ports. Also, in some optional or additional aspects, the fallback component 198 includes a measuring component 1230 configured to measure one or more channel metrics of a reference signal or a second reference signal and a mapping component 1235 configured to map, based on the one or more channel metrics and the number of antenna ports, the resource that is either indicated in a bitmap or by a value in a DCI message to a set antenna port identifiers.

Additional details of the fallback component 198 and/or any of the foregoing components are provided below, for example, with reference to FIGS. 4-23.

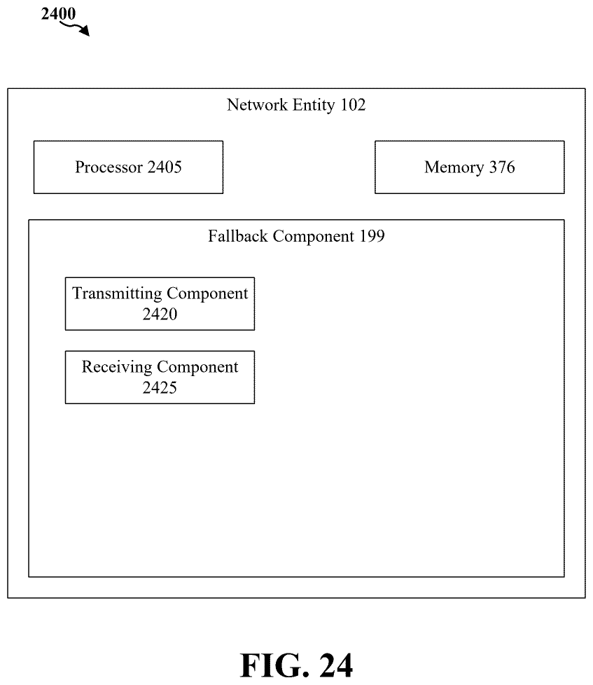

At one or more of the base stations 102 (or, network entities), and additionally referring to FIG. 24, the fallback component 199 includes a transmitting component 2420 configured to transmit an indication to reduce a number of antenna ports associated with uplink precoding. Further, the fallback component 199 includes a receiving component 2425 configured to receive a reference signal using the reduced number of antenna ports. Additionally, the transmitting component 2420 may be configured to transmit a message indicating a Transmit Precoder Matrix Indicator (TPMI) associated with the reduced number of antenna ports. Additional details of the fallback component 199 and/or any of the foregoing components are provided below, for example, with reference to FIGS. 4-11 and 24-33.

The base stations (or network entities) 102 may include macrocells (high power cellular base station) and/or small cells (low power cellular base station). The macrocells include base stations. The small cells include femtocells, picocells, and microcells. The base stations 102 can be configured in a Disaggregated RAN (D-RAN) or Open RAN (O-RAN) architecture, where functionality is split between multiple units such as a central unit (CU), one or more distributed units (DUs), or a radio unit (RU). Such architectures may be configured to utilize a protocol stack that is logically split between one or more units (such as one or more CUs and one or more DUs). In some aspects, the CUS may be implemented within an edge RAN node, and in some aspects, one or more DUs may be co-located with a CU, or may be geographically distributed throughout one or multiple RAN nodes. The DUs may be implemented to communicate with one or more RUs. Any of the disaggregated components in the D-RAN and/or O-RAN architectures may be referred to herein as a network entity.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (cNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). The frequencies between FR1 and FR2 are often referred to as mid-band frequencies. Although a portion of FR1 is greater than 6 GHZ, FRI is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHZ spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a network entity, gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, monitors, cameras, industrial/manufacturing devices, appliances, vehicles, robots, drones, etc.). IoT UEs may include machine type communications (MTC)/enhanced MTC (eMTC, also referred to as category (CAT)-M, Cat M1) UEs, NB-IoT (also referred to as CAT NB1) UEs, as well as other types of UEs. In the present disclosure, eMTC and NB-IoT may refer to future technologies that may evolve from or may be based on these technologies. For example, eMTC may include FeMTC (further eMTC), cFeMTC (enhanced further cMTC), mMTC (massive MTC), etc., and NB-IoT may include eNB-IoT (enhanced NB-IoT), FeNB-IoT (further enhanced NB-IoT), etc. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

FIG. 1B is a diagram illustrating an example of disaggregated base station 101 architecture, any component or element of which may be referred to herein as a network entity. The disaggregated base station 101 architecture may include one or more central units (CUs) 103 that can communicate directly with a core network 105 via a backhaul link, or indirectly with the core network 105 through one or more disaggregated base station units (such as a Near-Real Time (Near-RT) RAN Intelligent Controller (RIC) 107 via an E2 link, or a Non-Real Time (Non-RT) RIC 109 associated with a Service Management and Orchestration (SMO) Framework 111, or both). A CU 103 may communicate with one or more distributed units (DUs) 113 via respective midhaul links, such as an F1 interface. The DUs 113 may communicate with one or more radio units (RUs) 115 via respective fronthaul links. The RUs 115 may communicate with respective UEs 104 via one or more radio frequency (RF) access links. In some implementations, the UE 104 may be simultaneously served by multiple RUs 115.

Each of the units, e.g., the CUs 103, the DUs 113, the RUs 115, as well as the Near-RT RICs 107, the Non-RT RICs 109 and the SMO Framework 111, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 103 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 103. The CU 103 may be configured to handle user plane functionality (i.e., Central Unit-User Plane (CU-UP)), control plane functionality (i.e., Central Unit-Control Plane (CU-CP)), or a combination thereof. In some implementations, the CU 103 can be logically split into one or more CU-UP units and one or more CU-CP units. The CU-UP unit can communicate bidirectionally with the CU-CP unit via an interface, such as the E1 interface when implemented in an O-RAN configuration. The CU 103 can be implemented to communicate with the DU 113, as necessary, for network control and signaling.

The DU 113 may correspond to a logical unit that includes one or more base station functions to control the operation of one or more RUs 115. In some aspects, the DU 113 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the third Generation Partnership Project (3GPP). In some aspects, the DU 113 may further host one or more low PHY layers. Each layer (or module) can be implemented with an interface configured to communicate signals with other layers (and modules) hosted by the DU 113, or with the control functions hosted by the CU 103.

Lower-layer functionality can be implemented by one or more RUs 115. In some deployments, an RU 115, controlled by a DU 113, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 115 can be implemented to handle over the air (OTA) communication with one or more UEs 104. In some implementations, real-time and non-real-time aspects of control and user plane communication with the RU(s) 115 can be controlled by the corresponding DU 113. In some scenarios, this configuration can enable the DU(s) 113 and the CU 103 to be implemented in a cloud-based RAN architecture, such as a vRAN architecture.

The SMO Framework 111 may be configured to support RAN deployment and provisioning of non-virtualized and virtualized network elements. For non-virtualized network elements, the SMO Framework 111 may be configured to support the deployment of dedicated physical resources for RAN coverage requirements which may be managed via an operations and maintenance interface (such as an O1 interface). For virtualized network elements, the SMO Framework 111 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 103, DUs 113, RUs 115 and Near-RT RICs 107. In some implementations, the SMO Framework 111 can communicate with a hardware aspect of a 4G RAN, such as an open eNB (O-cNB) 117, via an O1 interface. Additionally, in some implementations, the SMO Framework 111 can communicate directly with one or more RUs 115 via an O1 interface. The SMO Framework 111 also may include a Non-RT RIC 109 configured to support functionality of the SMO Framework 111. The Non-RT RIC 109 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 107. The Non-RT RIC 109 may be coupled to or communicate with (such as via an A1 interface) the Near-RT RIC 107. The Near-RT RIC 107 may be configured to include a logical function that enables near-real-time control and optimization of RAN elements and resources via data collection and actions over an interface (such as via an E2 interface) connecting one or more CUs 103, one or more DUs 113, or both, as well as an O-eNB, with the Near-RT RIC 107.

In some implementations, to generate AI/ML models to be deployed in the Near-RT RIC 107, the Non-RT RIC 109 may receive parameters or external enrichment information from external servers. Such information may be utilized by the Near-RT RIC 107 and may be received at the SMO Framework 111 or the Non-RT RIC 109 from non-network data sources or from network functions. In some examples, the Non-RT RIC 109 or the Near-RT RIC 107 may be configured to tune RAN behavior or performance. For example, the Non-RT RIC 109 may monitor long-term trends and patterns for performance and employ AI/ML models to perform corrective actions through the SMO Framework 111 (such as reconfiguration via O1) or via creation of RAN management policies (such as A1 policies).

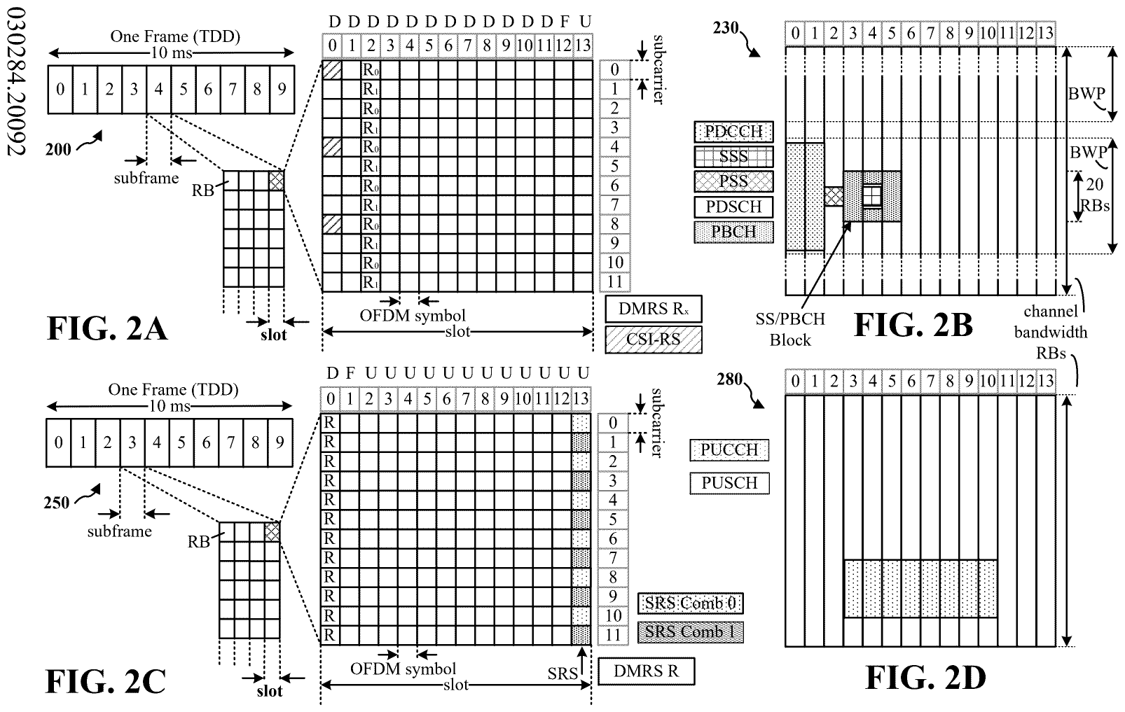

FIGS. 2A-2D are diagrams of various frame structures, resources, and channels used by UEs 104 and base stations 102/180 for communication. FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2^{μ} slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

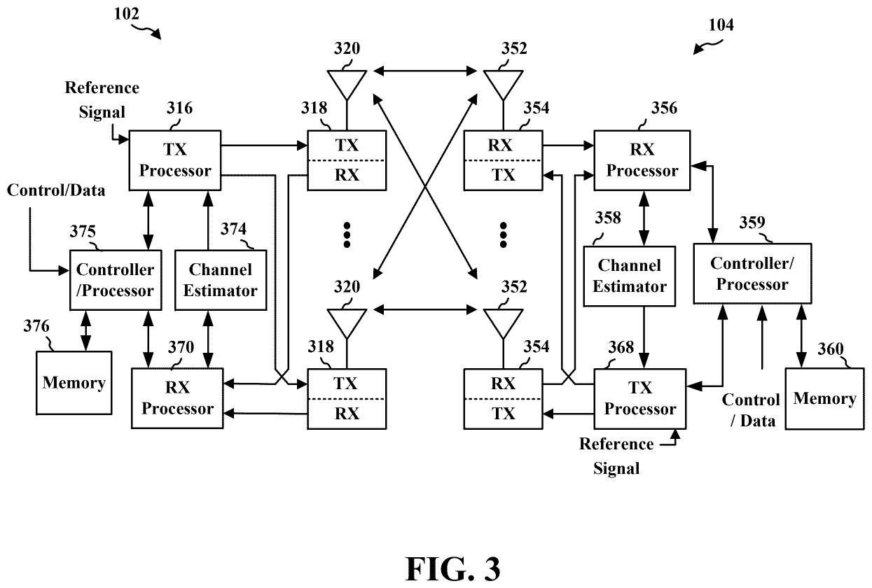

FIG. 3 is a block diagram of hardware components of the base station 102 (or 180) in communication with the UE 104 in the wireless communication network 100. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 104. Each spatial stream may then be provided to a different antenna 320 via a separate transmitter 318TX. Each transmitter 318TX may modulate an RF carrier with a respective spatial stream for transmission.

At the UE 104, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 104. If multiple spatial streams are destined for the UE 104, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 102. These soft decisions may be based on channel estimates computed by the channel estimator 358. The soft decisions are then decoded and deinterleaved to recover the data and control signals that were originally transmitted by the base station 102 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 102, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 102 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 102 in a manner similar to that described in connection with the receiver function at the UE 104. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 104. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with the fallback component 198 of FIG. 1A.

At least one of the TX processor 316, the RX processor 370, and the controller/processor 375 may be configured to perform aspects in connection with the fallback component 199 of FIG. 1A.

Referring to FIG. 4, example 400 shows a call flow between a network entity and a UE for fallback signaling to a fewer number of antenna ports. As described above, the network entity 102 may determine whether uplink traffic from UE 102 is low and in response transmit a fallback signal to the UE to reduce to a number of antenna ports.

For example, the network entity 102 may determine whether the uplink traffic is below a threshold uplink traffic amount or level over a threshold time period (e.g., threshold number of slots, threshold time duration, and the like).

At communication 402, based on determining that the UL traffic from UE 104 is low, the network entity 102 may be configured transmit a fallback signal and/or indication to the UE 104 to reduce number of antenna ports associated with uplink precoding. For example, if the UE 104 is configured with 8 antenna ports for transmitting uplink data and/or signals (e.g., 8 transmit (Tx) PUSCH), then the network entity 102 may transmit a fallback signal to the UE 104 to reduce the number of antenna ports to fewer than 8 antenna ports (e.g., 4 antenna ports (4 Tx PUSCH), 2 antenna ports (2 Tx PUSCH), 1 antenna port (e.g., 1 Tx PUSCH)) for uplink data and/or signal.

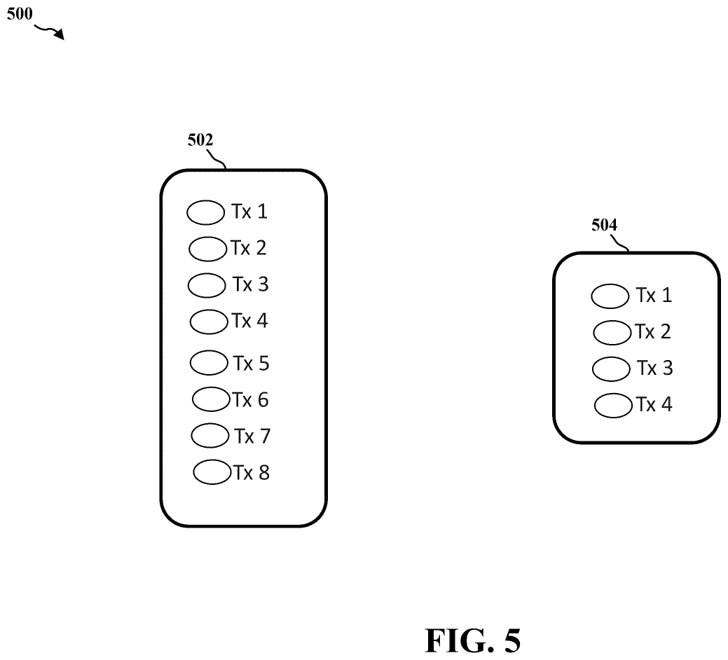

In some implementations, the network entity 102 may transmit the fallback signal and/or indication implicitly to the UE 104. For example, the network entity 102 may implicitly indicate or signal a fallback to fewer antenna ports for uplink data and/or signal by transmitting a configuration for a resource associated with a reference signal. For example, the network entity 102 may transmit a configuration for a Sounding Reference Signal (SRS) resource via an RRC message, where the configuration indicates the SRS with a new set of antenna ports. Example 500 of FIG. 5 illustrates such a fallback signal and/or indication.

In example 500 of FIG. 5, the UE 104 may have already been configured with a reference signal resource (e.g., an SRS resource) which is associated with 8 antenna ports (e.g., 8 SRS ports) of the UE 104, as indicated by the configuration 502, for transmitting the reference signal to the network entity. At communication 402, the network entity 102 may transmit the configuration 504 for a resource of the reference signal (e.g., an SRS resource). The configuration 504 may indicate that the reference signal resource is associated with fewer antenna ports than a resource of the reference signal with which the UE 104 may be have been previously configured with via the configuration 502. For example, configuration 504 may indicate that a resource of the reference (e.g., SRS resource) is associated with 4 antenna ports (e.g., 4 SRS ports).

The UE 104 may determine whether the communication at 402 from network entity is a fallback signal and/or indication if the number of associated antenna ports indicated in the configuration 504 are fewer than the number of antenna ports associated with the resource (e.g., SRS resource) with which the UE 104 is already configured via configuration 502. In example 500, since the number of antenna ports (4 antenna ports) in the configuration 504 is fewer than the number of antenna ports in configuration 502, then the UE 104 determines that the communication at 402 is a fallback signal and/or indication to reduce the number of antenna ports associated with uplink precoding and/or for uplink data and/or signal to 4 antenna ports.

In example 500, the configuration 504 may indicate the antenna port identifiers for the 4 ports, and referring back to FIG. 4, at block 404, the UE 104 may determine and/or identify the set of antenna port identifiers for the reduced antenna ports based on the antenna port identifiers indicated in configuration 504.

In some implementations, at communication 402 in FIG. 4, the network entity 102 may explicitly transmit the fallback signal and/or indication explicitly to the UE 104. In some implementations, the network entity 102 may explicitly indicate or signal a fallback to fewer antenna ports for uplink data and/or signal by indicating to switch between different resources (e.g., SRS resources) of the reference signal (e.g., SRS). The different resources of the reference signal may be configured with different number of antenna ports. The network entity 102 may transmit such a fallback signal and/or indication via a MAC CE message or a DCI message.

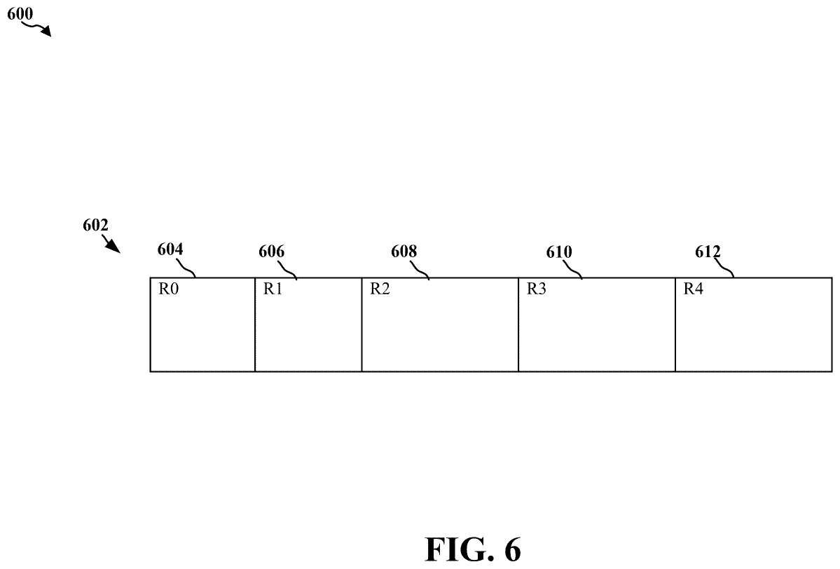

An example of explicit indication or signaling of fallback via a MAC CE message is shown in example 600 of FIG. 6. In example 600, bitmap 602 may be included in a MAC CE message. The bitmap 602 in the example 600 may include multiple bits, such as bits 604, 606, 608, 610, 612. Each of the bits 604, 606, 608, 610, 612 may correspond to different resources (e.g., SRS resources) of the reference signal (e.g., SRS). In some implementations, the UE 104 may be configured with a single resource set (e.g., SRS resource set) with one or more resources (e.g., SRS resources) in the resource set, and the bitmap 602 may be associated with the single resource set and each of the bits 604, 606, 608, 610, 612 may correspond to different resources of that resource set. In some implementations, the UE 104 may be configured with multiple resource sets (e.g., multiple SRS resource sets) with one or more resources (e.g., SRS resources) in each of the multiple resource sets, and the bitmap 602 may be associated with the multiple resource sets and each of the bits 604, 606, 608, 610, 612 may correspond with different resources from the different resource sets.

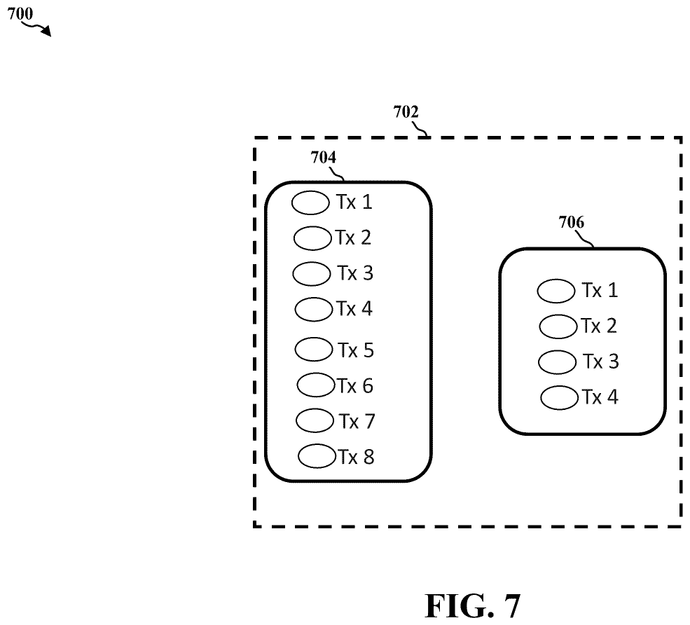

An example of the UE 104 being configured with a single resource set with multiple resources is shown in example 700 of FIG. 7. In example 700, the network entity 102 may configure the UE 104 with resource set 702. The resource set 702 may be an SRS resource set. The resource set 702 may include multiple resources (e.g., SRS resources) 704, 706. The different resources 704, 706 may be configured and/or associated with different number of antenna ports (e.g., SRS antenna ports, PUSCH antenna ports, and the like). For example, as shown in example 700, resource 704 may be configured and/or associated with 8 antenna ports (e.g., SRS antenna ports, PUSCH antenna ports), and 706 may be configured and/or associated with 4 antenna ports (e.g., SRS antenna ports, PUSCH antenna ports). The UE 104 may be configured with the single resource set by the network entity 102 via a configuration for the resource set 702 sent from the network entity 102. The UE 104 may receive the configuration for the resource set 702 via an RRC message.

Continuing with the above example, the bitmap 602 in FIG. 6 may be associated with the resource set 702, and bit 604 may correspond to the resource 704 and bit 606 may correspond to the resource 706. The network entity 102 may transmit the fallback signal and/or indication to reduce the number of antenna ports via the bitmap 602. For example, based on the UL traffic, if the network entity 102 determines that the UE 104 can fallback to 4 antenna ports, then the network entity 102 may transmit the fallback signal and/or indication by setting the bit 606 in the bitmap 602 and transmits the bitmap 602 via a MAC CE message.

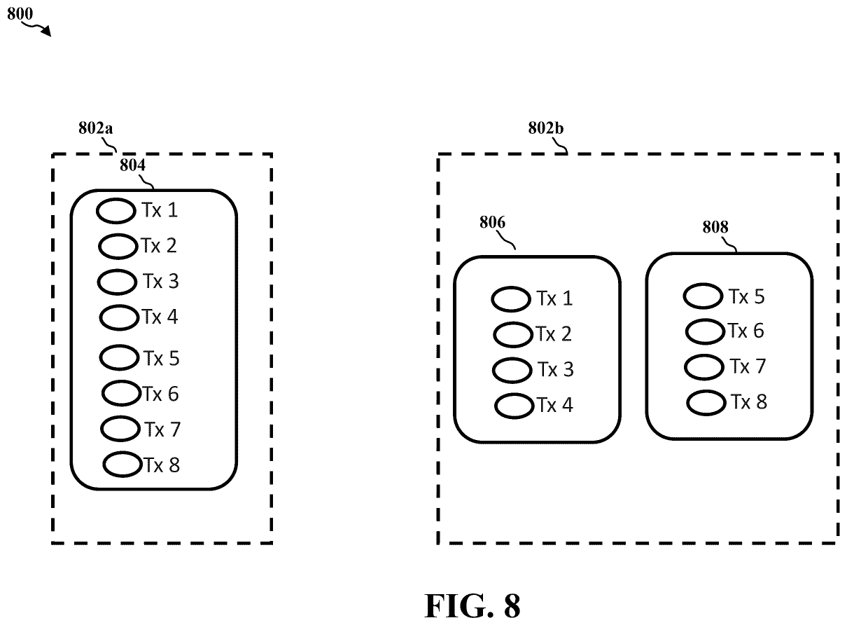

As described above, the UE 104 may be configured with multiple resource sets (e.g., multiple SRS resource sets) with one or more resources (SRS resources) in each of the multiple resource sets. An example of the UE 104 being configured with such multiple resource sets is shown in example 800 of FIG. 8. In example 800, the network entity 102 may configure the UE 104 with the resource sets 802a, 802b. The resource sets 802a, 802b may be SRS resource sets. Each of the resource sets 802a, 802b may include one or more resources (e.g., SRS resources). For example, as shown in FIG. 8, the resource set 802a may include resource (e.g., SRS resource) 804, and the resource set 802b may include resource (e.g., SRS resource) 806, 808. The different resources 804, 806, 808 may be configured and/or associated with different number of antenna ports (e.g., SRS antenna ports, PUSCH antenna ports, and the like). For example, as shown in example 800, resource 804 in the resource set 802a may be configured and/or associated with 8 antenna ports (e.g., SRS antenna ports, PUSCH antenna ports). Similarly, resource 806, 808 in the resource set 802b may be configured and/or associated with 4 antenna ports (e.g., SRS antenna ports, PUSCH antenna ports). The UE 104 may be configured with the multiple resource sets by the network entity 102 via a configuration for the multiple resource sets 802a, 802b sent from the network entity 102. The UE 104 may receive the configuration for the resource sets 802a, 802b via an RRC message.

The bitmap 602 in FIG. 6 may be associated with the resource sets 802a, 802b, and bit 608 may correspond to the resource 804, bit 610 may correspond to the resource 806, and bit 612 may correspond to the resource 808. As described above, the network entity 102 may transmit the fallback signal and/or indication to reduce the number of antenna ports via the bitmap 602. For example, based on the UL traffic, if the network entity 102 determines that the UE 104 can fallback to 4 antenna ports, and select the resource 808 from resource set 802b, then the network entity 102 may transmit the fallback signal and/or indication by setting the corresponding bit 612 in the bitmap 602 and transmits the bitmap 602 via a MAC CE message.

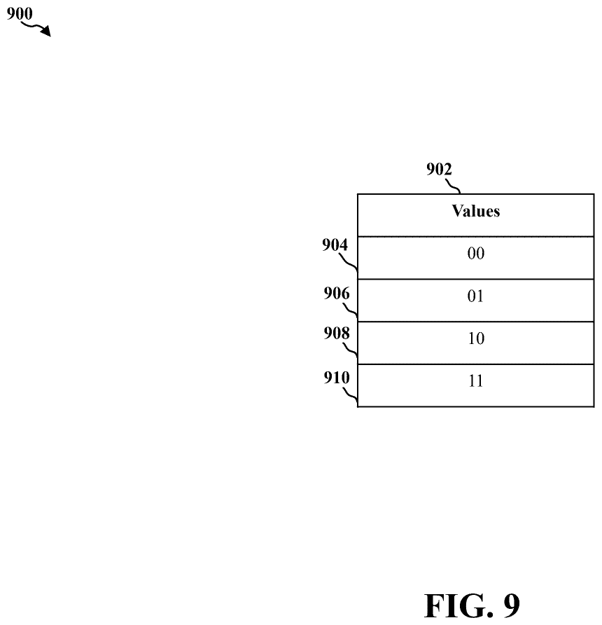

An example of explicit indication or signaling of fallback via a DCI message is shown in example 900 of FIG. 9. In example 900, a table 902 with different values (e.g., SRS Resource Indicator (SRI) values, and the like) that can be in a DCI message is shown. Each value in table 902 may correspond with a different reference signal resources (e.g., SRS resources). For example, value 904 may correspond to resource 704, value 906 may correspond to resource 706, value 908 may correspond to resource 806, value 910 may correspond to resource 808. Similarly, other values (e.g., SRI values) in DCI may correspond to other resources configured with a different number of antenna ports (e.g., 2 antenna ports, 1 antenna port, and the like). The network entity 102 may include one of the values in table 902 in a DCI message transmitted to the UE 104 to indicate and/or signal to the UE 104 to fallback to fewer antenna ports for uplink data and/or signal.

Referring back to FIG. 4, at block 404, the UE 104 may determine and/or map a set of antenna port identifiers of the UE 104 for the resource indicated by the network entity in the fallback signal and/or indication of communication 402. In some implementations the antenna port identifiers of the resource may be indicated and/or included in the configuration of the resource received by the UE 104. For example, the configurations of and/or associated with resources 704, 706, 804, 806, 808 may indicate and/or include antenna port identifiers for each of resources 704, 706, 804, 806, 808. For example, the configuration for resources 704, 706 may indicate a set of antenna port identifiers 1, 2, 3, 4, 5, 6, 7, 8 for resource 704 and/or may indicate a set of antenna port identifiers 1, 2, 3, 4 for resource 706. Similarly, the configuration for 804 may indicate a set of antenna port identifiers 1, 2, 3, 4, 5, 6, 7, 8, and the configuration for resources 806, 808 may indicate a set of antenna port identifiers 1,3,4,7 for resource 806, and antenna port identifiers 2, 5, 6, 8 for resource 808.

In some implementations, the UE 104 may be configured to determine and/or map a set of antenna port identifiers of the UE 104 autonomously based on channel metrics of a reference signal that the UE 104 may receive from the network entity 102. Examples of the channel metrics may include but are not limited to Reference Signal Received Power (RSRP), Received Signal Strength Indicator (RSSI), Reference Signal Received Quality (RSRQ), Signal to Interference and Noise Ratio (SINR), and the like. Examples of the reference signal based on which the UE 104 measures the channel metrics may be, but not limited to, CSI reference signal (CSI-RS), and the like. For example, the UE 104 may receive, from the network 102, the reference signal, such as CSI-RS, at an antenna port of the UE 104 (e.g., receive (Rx) port), and the UE 104 may measure and/or determine one or more of the channel metrics RSRP, RSSI, SINR, and the like based on the received CSI-RS. The UE 104 may receive such reference signal at different antenna ports and measure and/or determine the channel metrics at the different antenna ports based on the reference signals received at the different antenna ports.

In implementations where the UE 104 is configured to autonomously determine and/or map a set of antenna port identifiers of the UE 104, the configurations of the resources (e.g., SRS resources) may indicate a number of antenna ports for each of the resources. For example, the configuration resources 704, 706 may indicate and/or include 8 antenna ports for resource 704, and 4 antenna ports for resource 706. Similarly, the configuration for resource 804 may indicate and/or include 8 antenna ports, the configuration for resource 806 may indicate and/or include 4 antenna ports, and the configuration for resource 808 may indicate and/or include 4 antenna ports.

The UE 104 may determine and/or map antenna port identifiers autonomously based on the one or more channel metrics of the received reference signals (e.g., received CSI-RSs) and the respective number of antenna ports indicated and/or included in the configuration of a resource. In some implementations, the UE 104 may be configured to determine and/or identify antenna ports with best channel metrics and, based on the respective number of antenna ports indicated and/or included in the configuration of the resource (e.g., SRS resource), map a corresponding number of those antenna ports to the resource. For example, if the network entity, at communication 402 in FIG. 4, transmits fallback indication and/or signal by transmitting an indication to switch to resource 706, and its configuration indicates and/or includes the number of antenna ports as four, then the UE 104 may identify four of the best RSRP values (or any other channel metric described above) and select their corresponding and/or associated antenna ports to map to the resource 706.

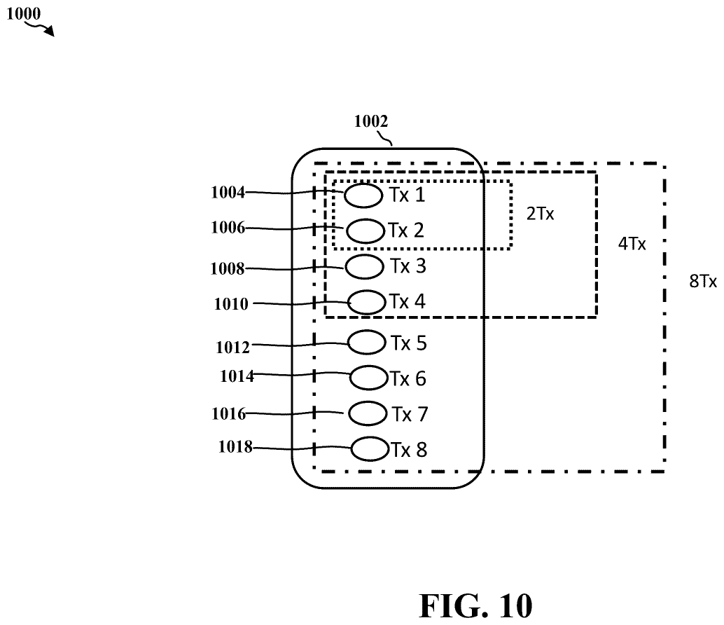

In some implementations, the UE 104 may be configured with one resource of the reference signal, and the resource may be configured with multiple antenna ports of the UE 104. An example of such a resource configuration is shown in example 1000 of FIG. 10. In example 1000, the UE 104 may be configured with a resource (e.g. SRS resource) 1002. The resource 1002 may be configured with and/or associated with antenna ports 1004, 1006, 1008, 1010, 1012, 1014, 1016, 1018. The network entity, at communication 402 in FIG. 4, may indicate or signal a fallback to fewer antenna ports for uplink data and/or signal by indicating the number of antenna port to fallback to by the UE 104. For example, the network entity 102 may transmit a message (e.g., a MAC CE, DCI, and the like) to UE 104 that indicates and/or includes four as the number of antenna ports to fallback to. Similarly, the network entity 102 may indicate and/or include in the message two, one, or any other number and/or value as the number of antenna ports to fallback to by the UE 104.

Based on the indicated number of antenna ports to fallback to, the UE 104, at block 404 of FIG. 4, may determine and/or identify the corresponding antenna port identifiers. In some implementations, the UE 104 may be determine and/or identify the corresponding antenna port identifiers based on one or more channel metrics (e.g., RSRP, RSSI, SINR, and the like) of a received reference signal (e.g., CSI-RS) as described above.

In some implementations, the network entity 102 may explicitly indicate a set of antenna port identifiers for the corresponding indicated number of antenna ports via a bitmap transmitted to the UE 104. In some implementations, a set of bits in the bitmap may correspond to the set of antenna port identifiers, and each bit in the set of bits may correspond to a respective antenna port identifier in the set of antenna port identifiers. In some implementations, the number of bits in the set of bits may correspond to the number of antenna ports that the UE 104 is configured with. For example, if the UE 104 is configured with 8 antenna ports, then the corresponding set of bits in the bitmap may include 8 bits, one bit for each of the 8 antenna ports. In some implementations, the bitmap may be bitmap 602, and the set of bits may be additional bits of the bitmap 602 now shown in FIG. 6.

In some implementations, the network entity 102 may explicitly indicate a set of antenna port identifiers for the corresponding indicated number of antenna ports via a DCI message transmitted to the UE 104. In some implementations, the DCI message may include a field or a reserved set of bits configured to indicate antenna port identifiers. For example, if the number of antenna ports to fallback to is four, the network entity 102 may indicate four antenna port identifiers via the field or via the reserved set of bits.

The UE 104 may be configured to increase or maintain the same transmit power (e.g., TxPower) per antenna port of the antenna ports that the UE 104 falls back to or per antenna port mapped to the resource 1002. For example, in example 1000, if the network entity 102 indicated the UE 104 to fallback to 4 antenna ports, then the UE 104 may increase the transmit power per antenna port of the 4 mapped antenna ports by 3 dB, such that the UE 104 may apply the precoder codebook

$$\frac{1}{\sqrt{8 / 2}} [ \begin{matrix}a \\ b \\ c \\ d \\ 0 \\ 0 \\ 0 \\ 0\end{matrix} ] ,$$

where a, b, c, d can be any value, for transmitting uplink transmissions. Alternatively, the UE 104 may maintain the same transmit power per antenna port of the 4 mapped antenna ports, such that the UE 104 may apply the precoder codebook

$$\frac{1}{\sqrt{8}} [ \begin{matrix}a \\ b \\ c \\ d \\ 0 \\ 0 \\ 0 \\ 0\end{matrix} ] .$$

Referring back to FIG. 4, at communication 406, the UE 104 may be configured to transmit the reference signal to the network entity 102 using the reduced and mapped antenna port identifiers. The reference signal, as described above, may be an SRS, and/or any other reference signal based on which the network entity 102 may be configured to measure and/or estimate channel metrics.

At block 408, the network entity 102 may be configured to select a precoder codebook a corresponding TPMI, and/or a corresponding rank and/or layer. The network entity 102 may measure and/or estimate channel metrics based on the reference signal received from the UE 104 at communication 406. The network entity 102 may select the precoder codebook, the corresponding TPMI, and/or the corresponding rank and/or layer based on the measured and/or estimated channel metrics and the number of antenna ports the UE 104 used to transmit the reference signal (e.g., SRS) and/or the number of antenna ports to which the UE 104 is indicated and/or signaled to fallback at communication 402.

Different number of antenna ports may be associated with different number of precoder codebooks. The different precoder codebooks may be nested and/or subset of other precoder codebooks. For example, a precoder codebook for one antenna port (e.g., 1 Tx precoder codebook) may be nested in and/or subset of a precoder codebook for two antenna ports (e.g., 2 Tx precoder codebook), a precoder codebook for two antenna ports (e.g., 2 Tx precoder codebook) may be nested in and/or subset of a precoder codebook for four antenna ports (e.g., 4 Tx precoder codebook), a precoder codebook for four antenna ports (e.g., 4 Tx precoder codebook) may be nested in and/or subset of a precoder codebook for eight antenna ports (e.g., 8 Tx precoder codebook).

An example of a rank one or one layer precoder codebook for eight antenna ports (e.g., 8 Tx precoder rank 1) may be

$$\frac{1}{\sqrt{8}} [ \begin{matrix}a \\ b \\ c \\ d \\ e \\ f \\ g \\ h\end{matrix} ] ,$$

where each of a, b, c, d, e, f, g, h may be any value (e.g., 1,−1, j,−j, and the like); an example of a rank one or one layer precoder codebook for four antenna ports (e.g., 4 Tx precoder rank 1) may be

$$\frac{1}{\sqrt{8}} [ \begin{matrix}m \\ p \\ t \\ u \\ 0 \\ 0 \\ 0 \\ 0\end{matrix} ] ,$$

where each of m, p, t, μ may be any value (e.g., 1,−1, j,−j, and the like); an example of a rank one or one layer precoder codebook for two antenna ports (e.g., 2 Tx precoder rank 1) may be

$$\frac{1}{\sqrt{8}} [ \begin{matrix}x \\ y \\ 0 \\ 0 \\ 0 \\ 0 \\ 0 \\ 0\end{matrix} ] ,$$

where each of x, y, may be any value (e.g., 1,−1, j,−j, and the like); an example of a rank one or one layer precoder codebook for one antenna port (e.g., 1 Tx precoder rank 1) may be

$$\frac{1}{\sqrt{8}} [ \begin{matrix}z \\ 0 \\ 0 \\ 0 \\ 0 \\ 0 \\ 0 \\ 0\end{matrix} ] ,$$

where z may be any value (e.g., 1,−1, j,−j, and the like). In some implementations, the UE 104 may be configured to turn off the RF and baseband of antenna ports of the UE 104 that correspond to the zero elements in the precoder codebook. For example, in the above precoder codebooks, if the first row of matrix of the precoder codebook corresponds to a first antenna port and/or an antenna port with an identifier 1, and if the second row corresponds to a second antenna port and/or an antenna port with an identifier 2, and so on, then the UE 104 may turn off the RF and baseband of the antenna ports 5, 6, 7, 8 if the UE 104 receives an indication (e.g., TPMI index) for the above example codebook for four antenna ports. Similarly, the UE 104 may turn off the RF and baseband of the antenna ports 3, 4, 5, 6, 7, 8 if the UE 104 receives an indication (e.g., TPMI index) for the above example codebook for two antenna ports, and may turn off the RF and baseband of the antenna ports 2, 3, 4, 5, 6, 7, 8, if the UE 104 receives an indication (e.g., TPMI index) for the above example codebook for one antenna port.

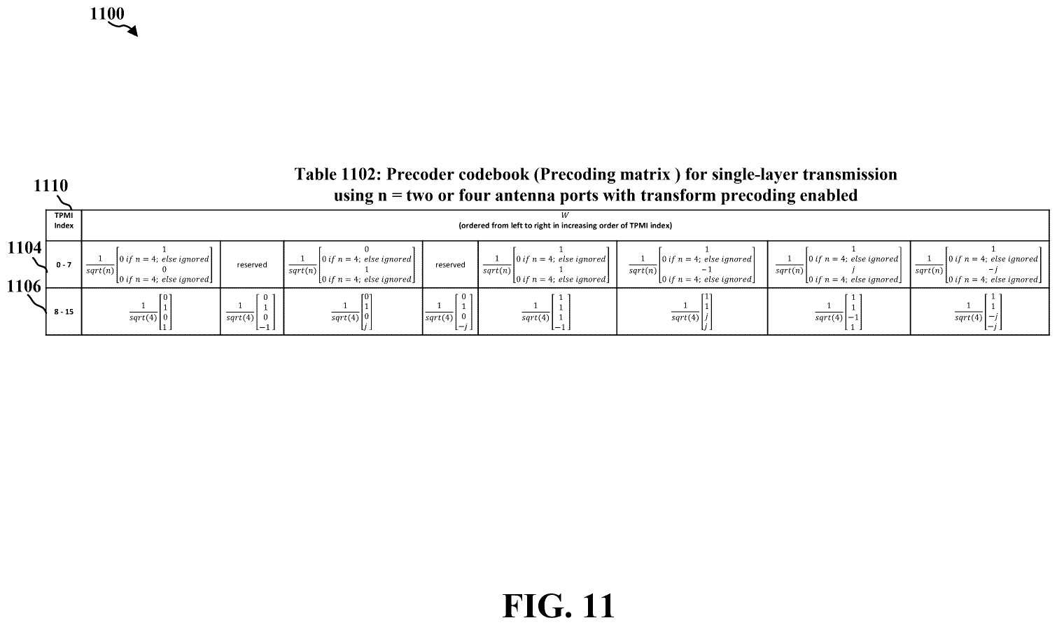

In some implementations, the different precoder codebooks may share a TPMI table. An example of different precoder codebooks sharing a TPMI table is shown in example 1100 in FIG. 11. In example 1100 of FIG. 11, TPMI table 1102 may include precoder codebooks for different number antenna ports. For example in row 1104, the TPMI table 1102 may include precoder codebooks for two antenna ports (e.g., 2 Tx precoder codebooks). Similarly, in row 1106, the TPMI table may include precoder codebooks for four antenna ports (e.g., 4 Tx precoder codebooks). In table 1102, the two antenna port precoder codebooks are nested in and/or subset of the four antenna port precoder codebooks. In some implementations, the coefficients of all of the precoder codebooks in a TPMI table may be the same. In some implementations, the coefficients of one set of precoder codebooks in a TPMI table may be the same, another set of precoder codebooks may be different, a third set of precoder codebooks may be different from the other two sets of precoder codebooks and the like.

The TPMI table 1102 may include a TPMI index 1110. Each value of the TPMI index may correspond to a precoder codebook in the TPMI table 1102. For example, TPMI index 0 may correspond to the leftmost precoder codebook in row 1104 of TPMI table 1102, and TPMI index 7 may correspond to the rightmost precoder codebook in row 1104 of TPMI table 1102, and TPMI indices 1-6 may correspond to the relative precoder codebooks between the leftmost precoder codebook and the rightmost precoder codebook in row 1104. Similarly, TPMI index 8 may correspond to the leftmost precoder codebook in row 1106, TPMI index 15 may correspond to the rightmost precoder codebook in row 1106, and TPMI indices 9-14 may correspond to the relative precoder codebooks between the leftmost precoder codebook and the rightmost precoder codebook in row 1106.

Referring back to FIG. 4, the network entity 102, at communication 410, may transmit control signal indicating the corresponding TPMI index of the selected precoder codebook and/or selected TPMI index. As described above, the selected TPMI index may be based on and/or associated with the number of antenna ports that the UE 104 falls back based on the communication 402 from network entity 102. The network entity 102 may indicate the selected TPMI index in a message to the UE 104. The UE 104 transmits an uplink data and/or signal (e.g., PUSCH transmission) to the network entity 102 using the precoder codebook indicated by the TPMI index and using the antenna ports mapped to the resource (e.g., SRS resource) of the reference signal (e.g., SRS) transmitted.

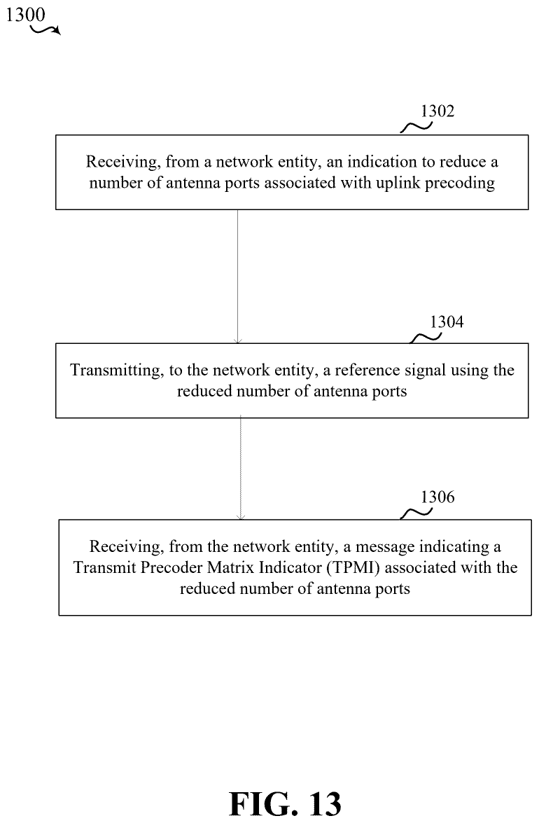

Referring to example 1200 of FIG. 12 and FIG. 13, in operation, UE 104 may perform a method 1300 of wireless communication, by such as via execution of fallback component 198 by processor 1205 and/or memory 360 (FIG. 3). In this case, the processor 1205 may be the receive (rx) processor 356, the controller/processor 359, and/or the transmit (tx) processor 368 described above in FIG. 3.

At block 1302, the method 1300 includes receiving, from a network entity, an indication to reduce a number of antenna ports associated with uplink precoding. For example, in an aspect, UE 104, processor 1205, memory 360, fallback component 198, and/or receiving component 1220 may be configured to or may comprise means for receiving, from a network entity, an indication to reduce a number of antenna ports associated with uplink precoding.

For example, the receiving at block 1302 may include receiving the indication via a wireless signal at an antenna or antenna array (e.g., antenna 352) as described in FIG. 3, and processing the received wireless signal and the indication as described above.

At block 1304, the method 1300 includes transmitting, to the network entity, a reference signal using the reduced number of antenna ports. For example, in an aspect, UE 104, processor 1205, memory 360, fallback component 198, and/or receiving component 1220 may be configured to or may comprise means for transmitting, to the network entity, a reference signal using the reduced number of antenna ports.

For example, the transmitting at block 1304 may include transmitting the reference signal via a wireless signal at an antenna or antenna array (e.g., antenna 352) as described in FIG. 3.

At block 1306, the method 1300 includes receiving, from the network entity, a message indicating a Transmit Precoder Matrix Indicator (TPMI) associated with the reduced number of antenna ports. For example, in an aspect, UE 104, processor 1205, memory 360, fallback component 198, and/or receiving component 1220 may be configured to or may comprise means for receiving, from the network entity, a message indicating a Transmit Precoder Matrix Indicator (TPMI) associated with the reduced number of antenna ports.

For example, the receiving at block 1306 may include receiving the message indicating TPMI via a wireless signal at an antenna or antenna array (e.g., antenna 352) as described in FIG. 3, and processing the received wireless signal and the message indicating the TPMI as described above.

In an alternative or additional aspect, the indication is received via a Radio Resource Control (RRC) message.

In an alternative or additional aspect, the indication associates the reference signal with a set of antenna ports and the reduced number of antenna ports is based on a number of antenna ports in the set of antenna ports.

In an alternative or additional aspect, the indication is received via a bitmap in a MAC CE message, or wherein the indication is received via a value in a DCI message.

In an alternative or additional aspect, each bit in the bitmap corresponds to a resource from a set of resources associated with the reference signal or wherein the value corresponds to the resource from the set of resources associated with the reference signal.

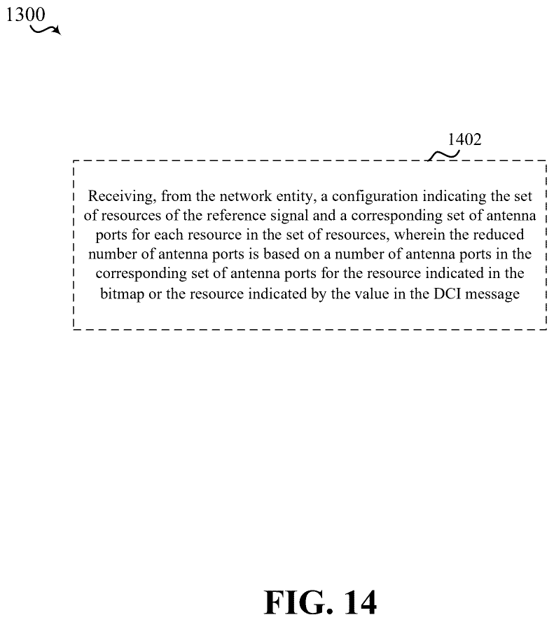

Referring to FIG. 14, in an alternative or additional aspect, at block 1402, where each bit in the bitmap corresponds to a resource from a set of resources associated with the reference signal or wherein the value corresponds to the resource from the set of resources associated with the reference signal, the method 1300 may further include receiving, from the network entity, a configuration indicating the set of resources of the reference signal and a corresponding set of antenna ports for each resource in the set of resources, wherein the reduced number of antenna ports is based on a number of antenna ports in the corresponding set of antenna ports for the resource indicated in the bitmap or the resource indicated by the value in the DCI message. For example, in an aspect, UE 104, processor 1205, memory 360, fallback component 198, and/or receiving component 1220 may be configured to or may comprise means for receiving, from the network entity, a configuration indicating the set of resources of the reference signal and a corresponding set of antenna ports for each resource in the set of resources, wherein the reduced number of antenna ports is based on a number of antenna ports in the corresponding set of antenna ports for the resource indicated in the bitmap or the resource indicated by the value in the DCI message.

For example, the receiving at block 1402 may include receiving the configuration via a wireless signal at an antenna or antenna array (e.g., antenna 352) as described in FIG. 3, and processing the received wireless signal and the third configuration as described above.

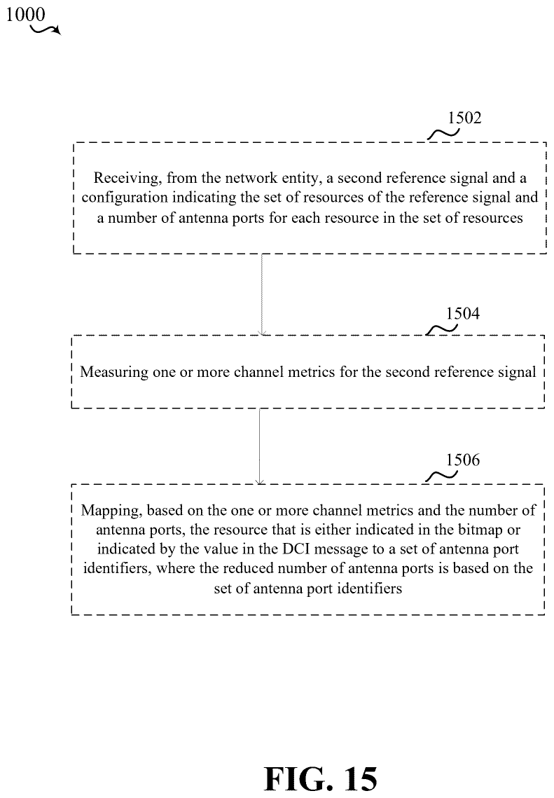

Referring to FIG. 15, in an alternative or additional aspect, at block 1502, where each bit in the bitmap corresponds to a resource from a set of resources associated with the reference signal or wherein the value corresponds to the resource from the set of resources associated with the reference signal, the method 1300 may further include, receiving, from the network entity, a second reference signal and a configuration indicating the set of resources of the reference signal and a number of antenna ports for each resource in the set of resources. For example, in an aspect, UE 104, processor 1205, memory 360, fallback component 198, and/or receiving component 1220 may be configured to or may comprise means for receiving, from the network entity, a second reference signal and a configuration indicating the set of resources of the reference signal and a number of antenna ports for each resource in the set of resources.

For example, the receiving at block 1502 may include receiving the second reference signal via a wireless signal at an antenna or antenna array (e.g., antenna 352) as described in FIG. 3, and processing the received wireless signal and the second reference signal as described above.

In this optional aspect, at block 1504, the method 1300 may further include measuring one or more channel metrics for the second reference signal. For example, in an aspect, UE 104, processor 1205, memory 360, fallback component 198, and/or measuring component 1230 may be configured to or may comprise means for measuring one or more channel metrics for the second reference signal.

In this optional aspect, at block 1506, the method 1300 may further include mapping, based on the one or more channel metrics and the number of antenna ports, the resource that is either indicated in the bitmap or indicated by the value in the DCI message to a set of antenna port identifiers, where the reduced number of antenna ports is based on the set of antenna port identifiers. For example, in an aspect, UE 104, processor 1205, memory 360, fallback component 198, and/or mapping component 1235 may be configured to or may comprise means for mapping, based on the one or more channel metrics and the number of antenna ports, the resource that is either indicated in the bitmap or indicated by the value in the DCI message to a set of antenna port identifiers, where the reduced number of antenna ports is based on the set of antenna port identifiers.

In an alternative or additional aspect, each bit in the bitmap corresponds to a resource from set of resources from a plurality of sets of resources associated with the reference signal or wherein the value corresponds to the resource set of resources from the plurality of sets of resources associated with the reference signal.

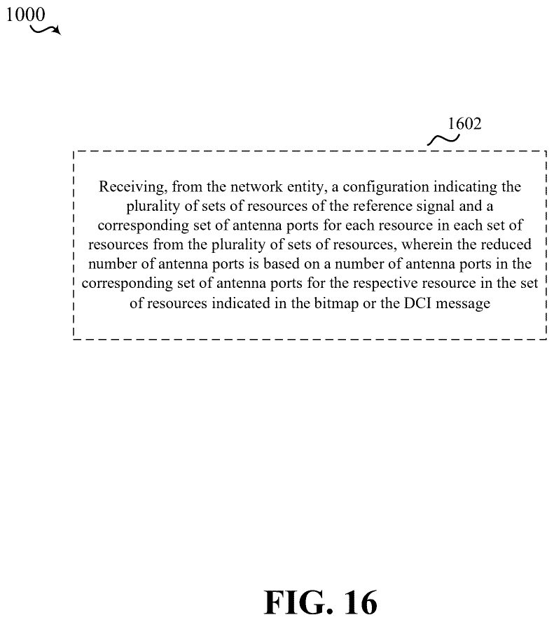

Referring to FIG. 16, in an alternative or additional aspect, at block 1602, where each bit in the bitmap corresponds to a resource from set of resources from a plurality of sets of resources associated with the reference signal or wherein the value corresponds to the resource set of resources from the plurality of sets of resources associated with the reference signal, the method 1300 may further include receiving, from the network entity, a configuration indicating the plurality of sets of resources of the reference signal and a corresponding set of antenna ports for each resource in each set of resources from the plurality of sets of resources, where the reduced number of antenna ports is based on a number of antenna ports in the corresponding set of antenna ports for the respective resource in the set of resources indicated in the bitmap or the DCI message. For example, in an aspect, UE 104, processor 1205, memory 360, fallback component 198, and/or receiving component 1220 may be configured to or may comprise means for receiving, from the network entity, a configuration indicating the plurality of sets of resources of the reference signal and a corresponding set of antenna ports for each resource in each set of resources from the plurality of sets of resources, where the reduced number of antenna ports is based on a number of antenna ports in the corresponding set of antenna ports for the respective resource in the set of resources indicated in the bitmap or the DCI message.

For example, the receiving at block 1602 may include receiving the configuration via a wireless signal at an antenna or antenna array (e.g., antenna 352) as described in FIG. 3, and processing the received wireless signal and the third configuration as described above.

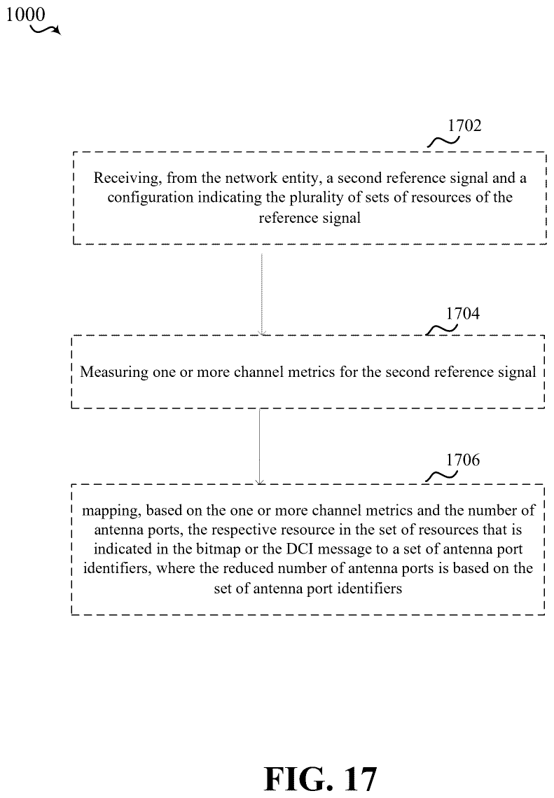

Referring to FIG. 17, in an alternative or additional aspect, at block 1702, where each bit in the bitmap corresponds to a resource from set of resources from a plurality of sets of resources associated with the reference signal or wherein the value corresponds to the resource set of resources from the plurality of sets of resources associated with the reference signal, the method 1300 may further include receiving, from the network entity, a second reference signal and a configuration indicating the plurality of sets of resources of the reference signal. For example, in an aspect, UE 104, processor 1205, memory 360, fallback component 198, and/or receiving component 1220 may be configured to or may comprise means for receiving, from the network entity, a second reference signal and a configuration indicating the plurality of sets of resources of the reference signal.

For example, the receiving at block 1702 may include receiving the second reference signal and the configuration via a wireless signal at an antenna or antenna array (e.g., antenna 352) as described in FIG. 3, and processing the received wireless signal and the second reference signal and the configuration as described above.

In this optional aspect, at block 1704, the method 1300 may further include measuring one or more channel metrics for the second reference signal. For example, in an aspect, UE 104, processor 1205, memory 360, fallback component 198, and/or measuring component 1230 may be configured to or may comprise means for measuring one or more channel metrics for the second reference signal.

In this optional aspect, at block 1706, the method 1300 may further include mapping, based on the one or more channel metrics and the number of antenna ports, the respective resource in the set of resources that is indicated in the bitmap or the DCI message to a set of antenna port identifiers, where the reduced number of antenna ports is based on the set of antenna port identifiers. For example, in an aspect, UE 104, processor 1205, memory 360, fallback component 198, and/or mapping component 1235 may be configured to or may comprise means for

In an alternative or additional aspect, the reference signal is a sounding reference signal (SRS).

In an alternative or additional aspect, the value is a SRS resource indicator (SRI) value indicated in the DCI message.

In an alternative or additional aspect, the reduced number of antenna ports are mapped to a set of preconfigured or defined port identifiers.

In an alternative or additional aspect, a resource of the reference signal is associated with a plurality of antenna ports of the apparatus equal to the number of antenna, and wherein the same resource is associated with the reduced number of antenna ports.

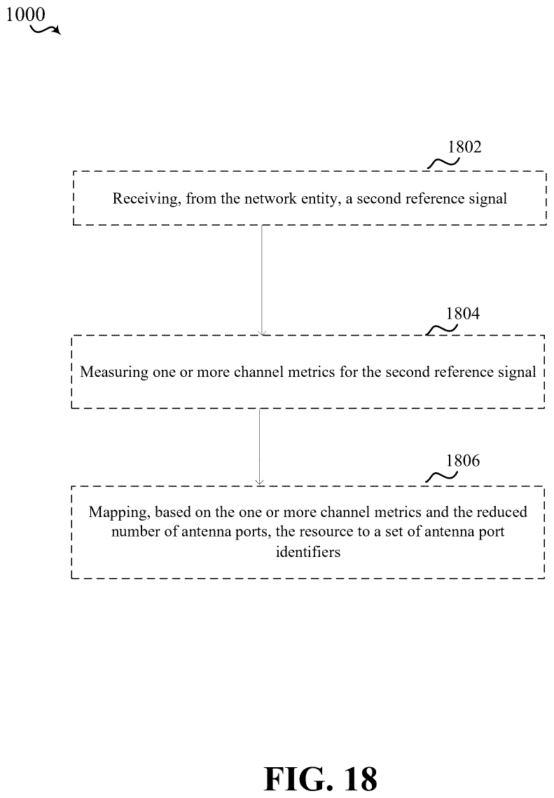

Referring to FIG. 18, in an alternative or additional aspect, at block 1802, where a resource of the reference signal is associated with a plurality of antenna ports of the apparatus equal to the number of antenna, and wherein the same resource is associated with the reduced number of antenna ports, the method 1300 may further include receiving, from the network entity, a second reference signal. For example, in an aspect, UE 104, processor 1205, memory 360, fallback component 198, and/or receiving component 1220 may be configured to or may comprise means for receiving, from the network entity, a second reference signal.

For example, the receiving at block 1802 may include receiving the second reference signal via a wireless signal at an antenna or antenna array (e.g., antenna 352) as described in FIG. 3, and processing the received wireless signal and the second reference signal as described above.

In this optional aspect, at block 1804, the method 1300 may further include measuring one or more channel metrics for the second reference signal. For example, in an aspect, UE 104, processor 1205, memory 360, fallback component 198, and/or measuring component 1230 may be configured to or may comprise means for measuring one or more channel metrics for the second reference signal.

In this optional aspect, at block 1806, the method 1300 may further include mapping, based on the one or more channel metrics and the reduced number of antenna ports, the resource to a set of antenna port identifiers. For example, in an aspect, UE 104, processor 1205, memory 360, fallback component 198, and/or mapping component 1235 may be configured to or may comprise means for mapping, based on the one or more channel metrics and the reduced number of antenna ports, the resource to a set of antenna port identifiers.

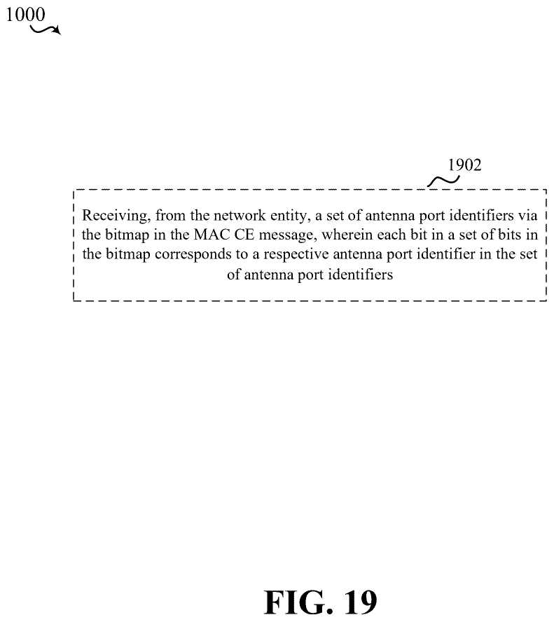

Referring to FIG. 19, in an alternative or additional aspect, at block 1902, where a resource of the reference signal is associated with a plurality of antenna ports of the apparatus equal to the number of antenna, and wherein the same resource is associated with the reduced number of antenna ports, the method 1300 may further include receiving, from the network entity, a set of antenna port identifiers via the bitmap in the MAC CE message, wherein each bit in a set of bits in the bitmap corresponds to a respective antenna port identifier in the set of antenna port identifiers. For example, in an aspect, UE 104, processor 1205, memory 360, fallback component 198, and/or receiving component 1220 may be configured to or may comprise means for receiving, from the network entity, a set of antenna port identifiers via the bitmap in the MAC CE message, wherein each bit in a set of bits in the bitmap corresponds to a respective antenna port identifier in the set of antenna port identifiers.

For example, the receiving at block 1902 may include receiving the set of antenna port identifiers via a wireless signal at an antenna or antenna array (e.g., antenna 352) as described in FIG. 3, and processing the received wireless signal and the set of antenna port identifiers as described above.

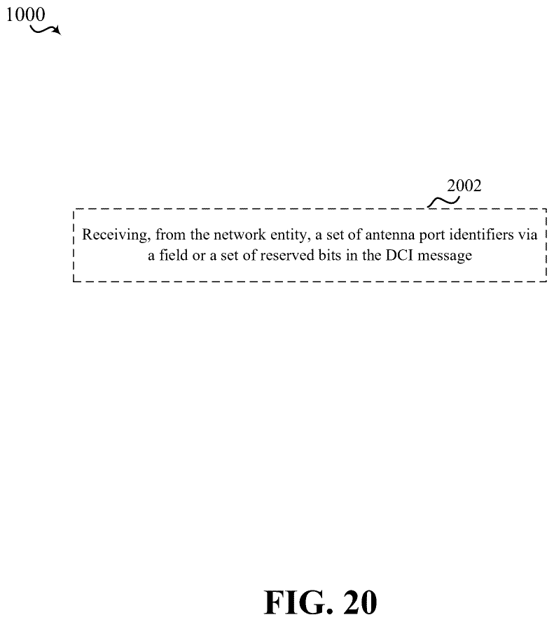

Referring to FIG. 20, in an alternative or additional aspect, at block 2002, where a resource of the reference signal is associated with a plurality of antenna ports of the apparatus equal to the number of antenna, and wherein the same resource is associated with the reduced number of antenna ports, the method 1300 may further include receiving, from the network entity, a set of antenna port identifiers via a field or a set of reserved bits in the DCI message. For example, in an aspect, UE 104, processor 1205, memory 360, fallback component 198, and/or receiving component 1220 may be configured to or may comprise means for receiving, from the network entity, a set of antenna port identifiers via a field or a set of reserved bits in the DCI message.

For example, the receiving at block 2002 may include receiving the set of antenna port identifiers via a wireless signal at an antenna or antenna array (e.g., antenna 352) as described in FIG. 3, and processing the received wireless signal and the set of antenna port identifiers as described above.

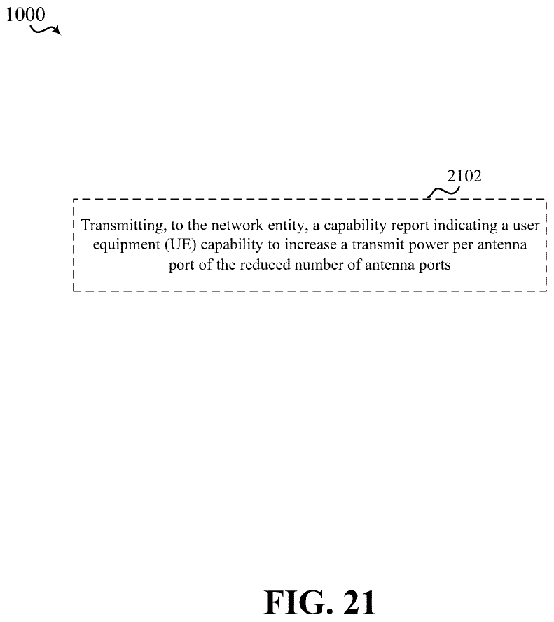

Referring to FIG. 21, in an alternative or additional aspect, at block 2102, the method 1300 may further include transmitting, to the network entity, a capability report indicating a user equipment (UE) capability to increase a transmit power per antenna port of the reduced number of antenna ports. For example, in an aspect, UE 104, processor 1205, memory 360, fallback component 198, and/or transmitting component 1225 may be configured to or may comprise means for transmitting, to the network entity, a capability report indicating a user equipment (UE) capability to increase a transmit power per antenna port of the reduced number of antenna ports.

For example, the transmitting at block 2102 may include transmitting the capability report via a wireless signal at an antenna or antenna array (e.g., antenna 352) as described in FIG. 3.

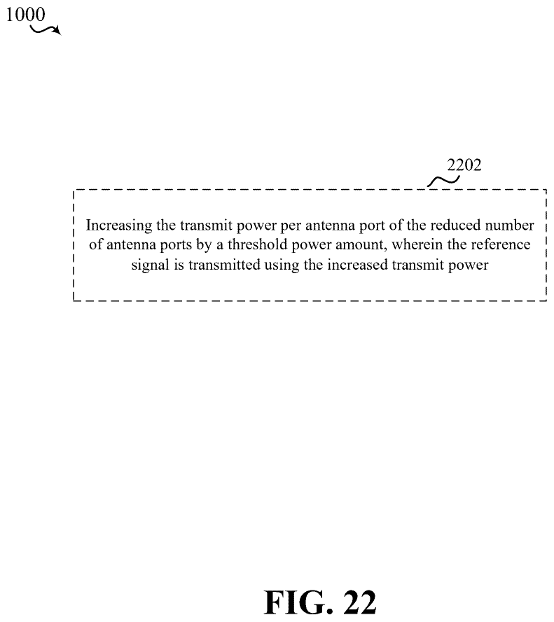

Referring to FIG. 22, in an alternative or additional aspect, at block 2202, the method 1300 may further include increasing the transmit power per antenna port of the reduced number of antenna ports by a threshold power amount, wherein the reference signal is transmitted using the increased transmit power. For example, in an aspect, UE 104, processor 1205, memory 360, fallback component 198, and/or transmit power component 1240 may be configured to or may comprise means for increasing the transmit power per antenna port of the reduced number of antenna ports by a threshold power amount, wherein the reference signal is transmitted using the increased transmit power.

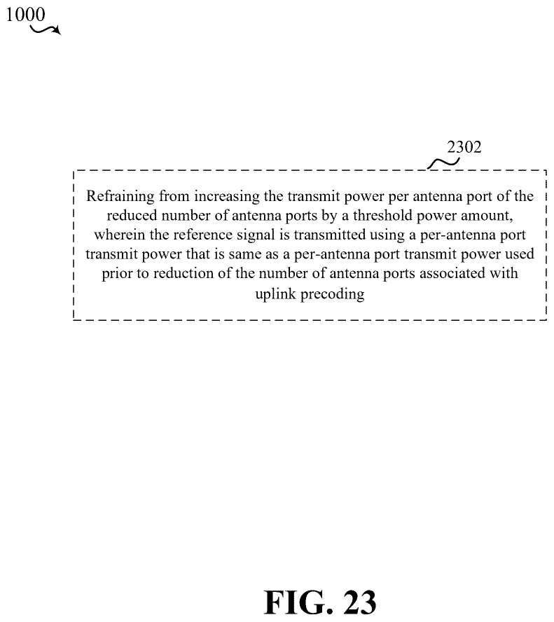

Referring to FIG. 23, in an alternative or additional aspect, at block 2302, the method 1300 may further include refraining from increasing the transmit power per antenna port of the reduced number of antenna ports by a threshold power amount, wherein the reference signal is transmitted using a per-antenna port transmit power that is same as a per-antenna port transmit power used prior to reduction of the number of antenna ports associated with uplink precoding. For example, in an aspect, UE 104, processor 1205, memory 360, fallback component 198, and/or transmit power component 1240 may be configured to or may comprise means for refraining from increasing the transmit power per antenna port of the reduced number of antenna ports by a threshold power amount, wherein the reference signal is transmitted using a per-antenna port transmit power that is same as a per-antenna port transmit power used prior to reduction of the number of antenna ports associated with uplink precoding.

In an alternative or additional aspect, the TPMI is associated with a precoding matrix in at least one precoding matrix table which includes matrices associated with different numbers of antenna ports.

In an alternative or additional aspect, the precoding matrix is associated with the reduced number of antenna ports.

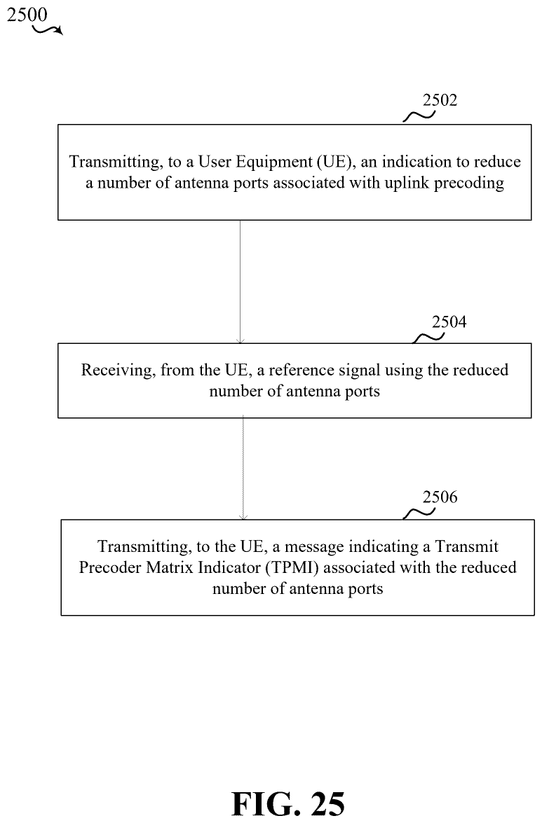

Referring to example 2400 of FIG. 24 and FIG. 25, in operation, network entity 102 may perform a method 2500 of wireless communication, by such as via execution of fallback component 199 by processor 2405 and/or memory 376 (FIG. 3). In this case, the processor 2405 may be the receive (rx) processor 370, the controller/processor 375, and/or the transmit (tx) processor 316 described above in FIG. 3.

At block 2502, the method 2500 includes transmitting, to a User Equipment (UE), an indication to reduce a number of antenna ports associated with uplink precoding. For example, in an aspect, network entity 102, processor 2405, memory 376, fallback component 199, and/or transmitting component 2420 may be configured to or may comprise means for transmitting, to a User Equipment (UE), an indication to reduce a number of antenna ports associated with uplink precoding.

For example, the transmitting at block 2502 may include transmitting the indication via a wireless signal at an antenna or antenna array (e.g., antenna 320) as described in FIG. 3.

At block 2504, the method 2500 includes receiving, from the UE, a reference signal using the reduced number of antenna ports. For example, in an aspect, network entity 102, processor 2405, memory 376, fallback component 199, and/or receiving component 2425 may be configured to or may comprise means for receiving, from the UE, a reference signal using the reduced number of antenna ports.

For example, the receiving at block 2504 may include receiving the reference signal via a wireless signal at an antenna or antenna array (e.g., antenna 320) as described in FIG. 3, and processing the received wireless signal and the reference signal as described above.

At block 2506, the method 2500 includes transmitting, to the UE, a message indicating a Transmit Precoder Matrix Indicator (TPMI) associated with the reduced number of antenna ports. For example, in an aspect, network entity 102, processor 2405, memory 376, fallback component 199, and/or transmitting component 2420 or receiving component 2425 may be configured to or may comprise means for transmitting, to the UE, a message indicating a Transmit Precoder Matrix Indicator (TPMI) associated with the reduced number of antenna ports.

For example, the transmitting at block 2506 may include transmitting the message via a wireless signal at an antenna or antenna array (e.g., antenna 320) as described in FIG. 3.

In an alternative or additional aspect, the indication is received via a Radio Resource Control (RRC) message.

In an alternative or additional aspect, the indication associates the reference signal with a set of antenna ports and the reduced number of antenna ports is based on a number of antenna ports in the set of antenna ports.

In an alternative or additional aspect, the indication is transmitted via a bitmap in a medium access control (MAC) control element (CE) message, or wherein the indication is transmitted via a value in a downlink control information (DCI) message.

In an alternative or additional aspect, each bit in the bitmap corresponds to a resource from a set of resources associated with the reference signal or wherein the value corresponds to the resource from the set of resources associated with the reference signal.

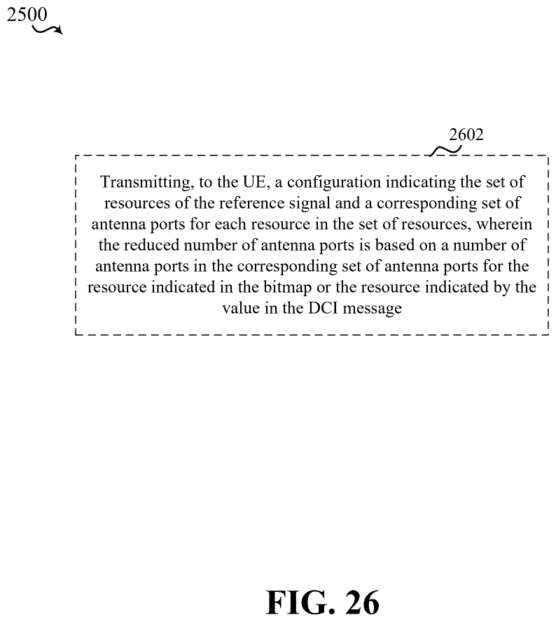

Referring to FIG. 26, in an alternative or additional aspect, at block 2602, where each bit in the bitmap corresponds to a resource from a set of resources associated with the reference signal or wherein the value corresponds to the resource from the set of resources associated with the reference signal, the method 2500 may further include transmitting, to the UE, a configuration indicating the set of resources of the reference signal and a corresponding set of antenna ports for each resource in the set of resources, wherein the reduced number of antenna ports is based on a number of antenna ports in the corresponding set of antenna ports for the resource indicated in the bitmap or the resource indicated by the value in the DCI message. For example, in an aspect, network entity 102, processor 2405, memory 376, fallback component 199, and/or transmitting component 2420 may be configured to or may comprise means for transmitting, to the UE, a configuration indicating the set of resources of the reference signal and a corresponding set of antenna ports for each resource in the set of resources, wherein the reduced number of antenna ports is based on a number of antenna ports in the corresponding set of antenna ports for the resource indicated in the bitmap or the resource indicated by the value in the DCI message.

For example, the transmitting at block 2602 may include transmitting the configuration via a wireless signal at an antenna or antenna array (e.g., antenna 320) as described in FIG. 3.

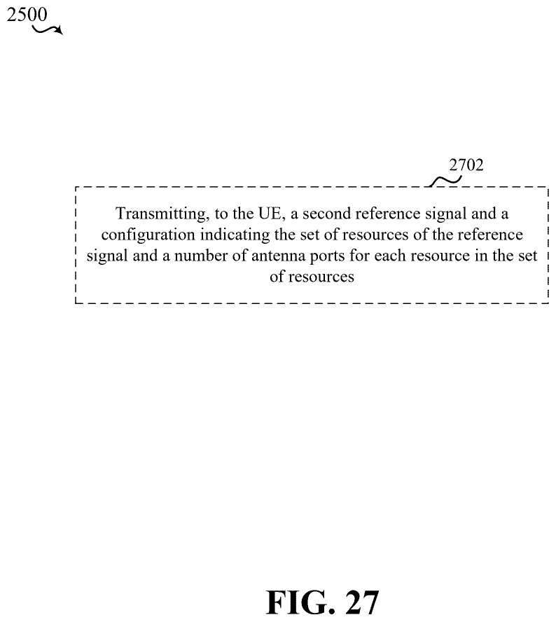

Referring to FIG. 27, in an alternative or additional aspect, at block 2702, where each bit in the bitmap corresponds to a resource from a set of resources associated with the reference signal or wherein the value corresponds to the resource from the set of resources associated with the reference signal, the method 2500 may further include, transmitting, to the UE, a second reference signal and a configuration indicating the set of resources of the reference signal and a number of antenna ports for each resource in the set of resources. For example, in an aspect, network entity 102, processor 2405, memory 376, fallback component 199, and/or transmitting component 2420 may be configured to or may comprise means for transmitting, to the UE, a second reference signal and a configuration indicating the set of resources of the reference signal and a number of antenna ports for each resource in the set of resources.

For example, the transmitting at block 2702 may include transmitting the second reference signal and the configuration via a wireless signal at an antenna or antenna array (e.g., antenna 320) as described in FIG. 3.

In an alternative or additional aspect, each bit in the bitmap corresponds to a resource from a plurality of sets of resources associated with the reference signal or wherein the value corresponds to the resource from the plurality of sets of resources associated with the reference signal.

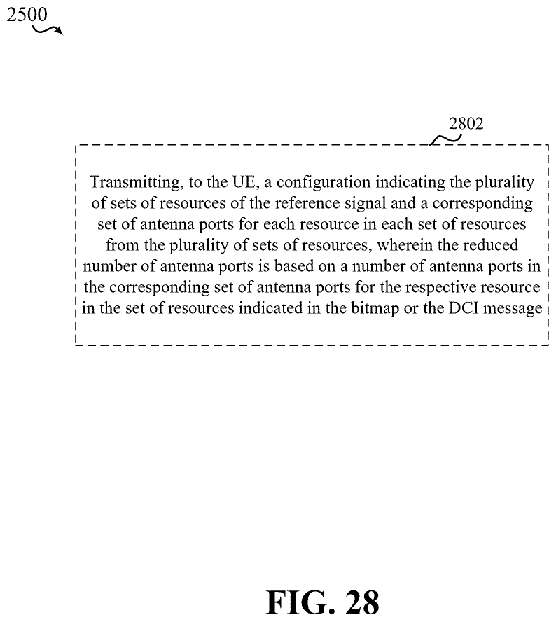

Referring to FIG. 28, in an alternative or additional aspect, at block 2802, where each bit in the bitmap corresponds to a resource from a plurality of sets of resources associated with the reference signal or wherein the value corresponds to the resource from the plurality of sets of resources associated with the reference signal, the method 2500 may further include, transmitting, to the UE, a configuration indicating the plurality of sets of resources of the reference signal and a corresponding set of antenna ports for each resource in each set of resources from the plurality of sets of resources, wherein the reduced number of antenna ports is based on a number of antenna ports in the corresponding set of antenna ports for the respective resource in the set of resources indicated in the bitmap or the DCI message. For example, in an aspect, network entity 102, processor 2405, memory 376, fallback component 199, and/or transmitting component 2420 may be configured to or may comprise means for transmitting, to the UE, a configuration indicating the plurality of sets of resources of the reference signal and a corresponding set of antenna ports for each resource in each set of resources from the plurality of sets of resources, wherein the reduced number of antenna ports is based on a number of antenna ports in the corresponding set of antenna ports for the respective resource in the set of resources indicated in the bitmap or the DCI message.

For example, the transmitting at block 2802 may include transmitting the configuration via a wireless signal at an antenna or antenna array (e.g., antenna 320) as described in FIG. 3.

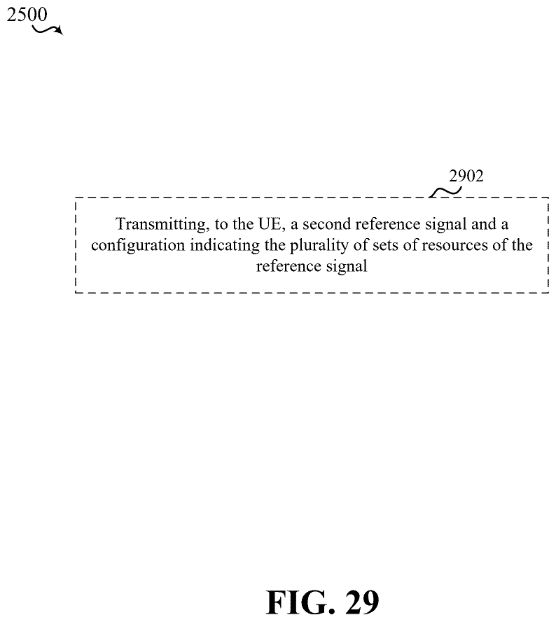

Referring to FIG. 29, in an alternative or additional aspect, at block 2902, where each bit in the bitmap corresponds to a resource from a plurality of sets of resources associated with the reference signal or wherein the value corresponds to the resource from the plurality of sets of resources associated with the reference signal, the method 2500 may further include, transmitting, to the UE, a second reference signal and a configuration indicating the plurality of sets of resources of the reference signal. For example, in an aspect, network entity 102, processor 2405, memory 376, fallback component 199, and/or transmitting component 2420 may be configured to or may comprise means for transmitting, to the UE, a second reference signal and a configuration indicating the plurality of sets of resources of the reference signal.

For example, the transmitting at block 2902 may include transmitting the second reference signal via a wireless signal at an antenna or antenna array (e.g., antenna 320) as described in FIG. 3.

In an alternative or additional aspect, the reference signal is a sounding reference signal (SRS).

In an alternative or additional aspect, the value is a SRS resource indicator (SRI) value indicated in the DCI message.

In an alternative or additional aspect, the reduced number of antenna ports are mapped to a set of preconfigured or defined port identifiers.

In an alternative or additional aspect, a resource of the reference signal is associated with a plurality of antenna ports of the apparatus equal to the number of antenna, and wherein the same resource is associated with the reduced number of antenna ports.

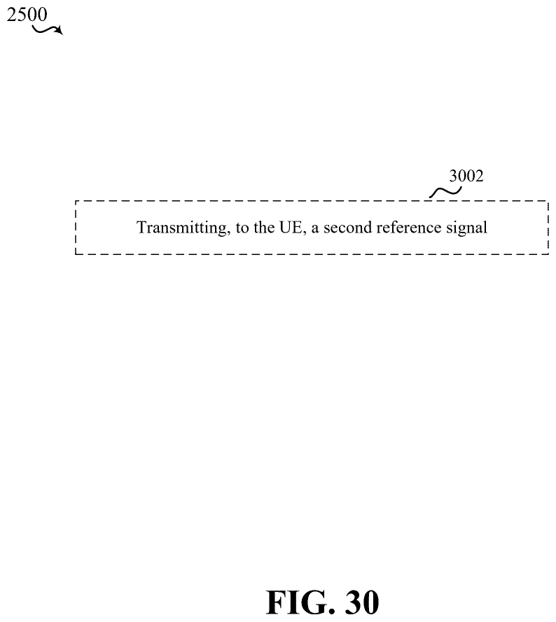

Referring to FIG. 30, in an alternative or additional aspect, at block 3002, where a resource of the reference signal is associated with a plurality of antenna ports of the apparatus equal to the number of antenna, and wherein the same resource is associated with the reduced number of antenna ports, the method 2500 may further include transmitting, to the UE, a second reference signal. For example, in an aspect, network entity 102, processor 2405, memory 376, fallback component 199, and/or transmitting component 2420 may be configured to or may comprise means for transmitting, to the UE, a second reference signal.

For example, the transmitting at block 3002 may include transmitting the second reference signal via a wireless signal at an antenna or antenna array (e.g., antenna 320) as described in FIG. 3.

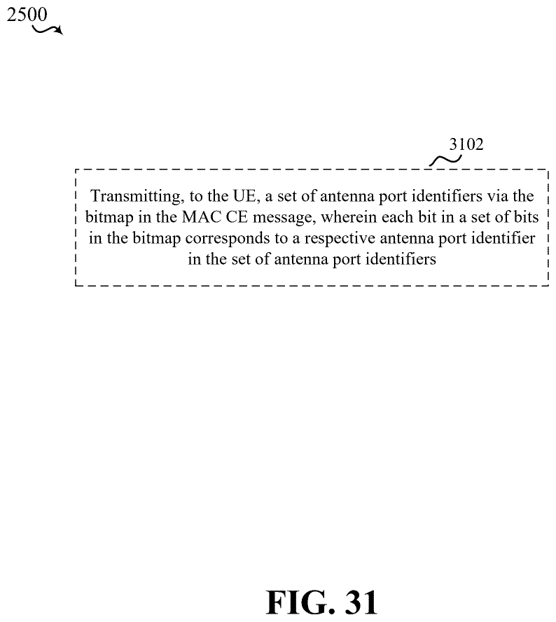

Referring to FIG. 31, in an alternative or additional aspect, at block 3102, where a resource of the reference signal is associated with a plurality of antenna ports of the apparatus equal to the number of antenna, and wherein the same resource is associated with the reduced number of antenna ports, the method 2500 may further include transmitting, to the UE, a set of antenna port identifiers via the bitmap in the MAC

CE message, wherein each bit in a set of bits in the bitmap corresponds to a respective antenna port identifier in the set of antenna port identifiers. For example, in an aspect, network entity 102, processor 2405, memory 376, fallback component 199, and/or transmitting component 2420 may be configured to or may comprise means for transmitting, to the UE, a set of antenna port identifiers via the bitmap in the MAC CE message, wherein each bit in a set of bits in the bitmap corresponds to a respective antenna port identifier in the set of antenna port identifiers.

For example, the transmitting at block 3102 may include transmitting the set of antenna port identifiers via a wireless signal at an antenna or antenna array (e.g., antenna 320) as described in FIG. 3.

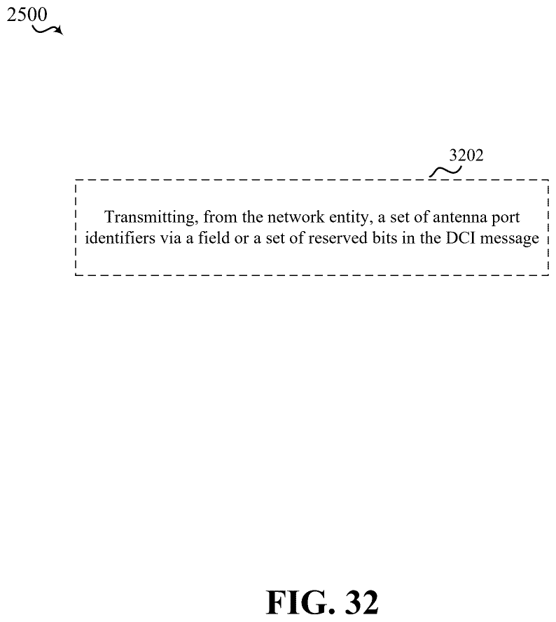

Referring to FIG. 32, in an alternative or additional aspect, at block 3202, where a resource of the reference signal is associated with a plurality of antenna ports of the apparatus equal to the number of antenna, and wherein the same resource is associated with the reduced number of antenna ports, the method 2500 may further include transmitting, from the network entity, a set of antenna port identifiers via a field or a set of reserved bits in the DCI message. For example, in an aspect, network entity 102, processor 2405, memory 376, fallback component 199, and/or transmitting component 2420 may be configured to or may comprise means for transmitting, from the network entity, a set of antenna port identifiers via a field or a set of reserved bits in the DCI message.

For example, the transmitting at block 3202 may include transmitting the set of antenna port identifiers via a wireless signal at an antenna or antenna array (e.g., antenna 320) as described in FIG. 3.

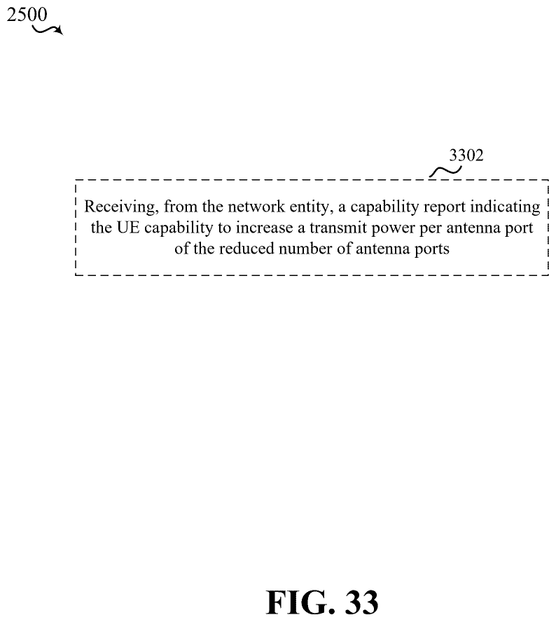

Referring to FIG. 33, in an alternative or additional aspect, at block 3302, the method 2500 may further include receiving, from the network entity, a capability report indicating the UE capability to increase a transmit power per antenna port of the reduced number of antenna ports. For example, in an aspect, network entity 102, processor 2405, memory 376, fallback component 199, and/or receiving component 2425 may be configured to or may comprise means for receiving, from the network entity, a capability report indicating the UE capability to increase a transmit power per antenna port of the reduced number of antenna ports.

For example, the receiving at block 3302 may include receiving the capability report via a wireless signal at an antenna or antenna array (e.g., antenna 320) as described in FIG. 3, and processing the received wireless signal and the capability report as described above.

In an alternative or additional aspect, the TPMI is associated with a precoding matrix in at least one precoding matrix table which includes matrices associated with different numbers of antenna ports.

In an alternative or additional aspect, the precoding matrix is associated with the reduced number of antenna ports.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following examples are illustrative only and may be combined with aspects of other embodiments, implementations, or teachings described herein, without limitation.

Example 1 is a method of wireless communication at a user equipment, comprising: receiving, from a network entity, an indication to reduce a number of antenna ports associated with uplink precoding; transmitting, to the network entity, a reference signal using the reduced number of antenna ports; and receiving, from the network entity, a message indicating a Transmit Precoder Matrix Indicator (TPMI) associated with the reduced number of antenna ports.

Example 2 is the method of example 1, wherein the indication is received via a Radio Resource Control (RRC) message.

Example 3 is the method of example 2, wherein the indication associates the reference signal with a set of antenna ports and the reduced number of antenna ports is based on a number of antenna ports in the set of antenna ports.

Example 4 is the method of any of examples 1-3, wherein the indication is received via a bitmap in a medium access control (MAC) control element (CE) message, or wherein the indication is received via a value in a downlink control information (DCI) message.

Example 5 is the method of example 4, wherein each bit in the bitmap corresponds to a resource from a set of resources associated with the reference signal or wherein the value corresponds to the resource from the set of resources associated with the reference signal.

Example 6 is the method of example 5, further comprising: receiving, from the network entity, a configuration indicating the set of resources of the reference signal and a corresponding set of antenna ports for each resource in the set of resources, wherein the reduced number of antenna ports is based on a number of antenna ports in the corresponding set of antenna ports for the resource indicated in the bitmap or the resource indicated by the value in the DCI message.

Example 7 is the method of example 5, further comprising: receiving, from the network entity, a second reference signal and a configuration indicating the set of resources of the reference signal and a number of antenna ports for each resource in the set of resources; measuring one or more channel metrics for the second reference signal; and mapping, based on the one or more channel metrics and the number of antenna ports, the resource that is either indicated in the bitmap or indicated by the value in the DCI message to a set of antenna port identifiers, wherein the reduced number of antenna ports is based on the set of antenna port identifiers.

Example 8 is the method of example 4, wherein each bit in the bitmap corresponds to a resource from a plurality of sets of resources associated with the reference signal or wherein the value corresponds to the resource from the plurality of sets of resources associated with the reference signal.

Example 9 is the method of example 8, further comprising: receiving, from the network entity, a configuration indicating the plurality of sets of resources of the reference signal and a corresponding set of antenna ports for each resource in each set of resources from the plurality of sets of resources, wherein the reduced number of antenna ports is based on a number of antenna ports in the corresponding set of antenna ports for the respective resource in the set of resources indicated in the bitmap or the DCI message.

Example 10 is the method of example 8, further comprising: receiving, from the network entity, a second reference signal and a configuration indicating the plurality of sets of resources of the reference signal; measuring one or more channel metrics for the second reference signal; and mapping, based on the one or more channel metrics and the number of antenna ports, the respective resource in the set of resources that is indicated in the bitmap or the DCI message to a set of antenna port identifiers, wherein the reduced number of antenna ports is based on the set of antenna port identifiers.

Example 11 is the method of example 5, wherein the reference signal is a sounding reference signal (SRS).

Example 12 is the method of example 5, wherein the value is a SRS resource indicator (SRI) value indicated in the DCI message.

Example 13 is the method of example 5, wherein the reduced number of antenna ports are mapped to a set of preconfigured or defined port identifiers.

Example 14 is the method of example 4, wherein a resource of the reference signal is associated with a plurality of antenna ports of the apparatus equal to the number of antenna, and wherein the same resource is associated with the reduced number of antenna ports.

Example 15 is the method of example 14, further comprising: receiving, from the network entity, a second reference signal; measuring one or more channel metrics for the second reference signal; and mapping, based on the one or more channel metrics and the reduced number of antenna ports, the resource to a set of antenna port identifiers.

Example 16 is the method of example 14, further comprising: receiving, from the network entity, a set of antenna port identifiers via the bitmap in the MAC CE message, wherein each bit in a set of bits in the bitmap corresponds to a respective antenna port identifier in the set of antenna port identifiers.

Example 17 is the method of example 14, further comprising: receiving, from the network entity, a set of antenna port identifiers via a field or a set of reserved bits in the DCI message.

Example 18 is the method of any of examples 1-17, further comprising: transmitting, to the network entity, a capability report indicating a user equipment (UE) capability to increase a transmit power per antenna port of the reduced number of antenna ports.

Example 19 is the method of example 18, further comprising: increasing the transmit power per antenna port of the reduced number of antenna ports by a threshold power amount, wherein the reference signal is transmitted using the increased transmit power.

Example 20 is the method of example 18, further comprising: refraining from increasing the transmit power per antenna port of the reduced number of antenna ports by a threshold power amount, wherein the reference signal is transmitted using a per-antenna port transmit power that is same as a per-antenna port transmit power used prior to reduction of the number of antenna ports associated with uplink precoding.

Example 21 is the method of any of examples 1-20, wherein the TPMI is associated with a precoding matrix in at least one precoding matrix table which includes matrices associated with different numbers of antenna ports.

Example 22 is the method of example 21, wherein the precoding matrix is associated with the reduced number of antenna ports.

Example 23 is a method of wireless communication at a user equipment, comprising: transmitting, to a User Equipment (UE), an indication to reduce a number of antenna ports associated with uplink precoding; receiving, from the UE, a reference signal using the reduced number of antenna ports; and transmitting, to the UE, a message indicating a Transmit Precoder Matrix Indicator (TPMI) associated with the reduced number of antenna ports.

Example 24 is the method of example 23, wherein the indication is transmitted via a Radio Resource Control (RRC) message.

Example 25 is the method of example 24, wherein the indication associates the reference signal with a set of antenna ports and the reduced number of antenna ports is based on a number of antenna ports in the set of antenna ports.

Example 26 is the method of any examples 23-25, wherein the indication is transmitted via a bitmap in a medium access control (MAC) control element (CE) message, or wherein the indication is transmitted via a value in a downlink control information (DCI) message.

Example 27 is the method of example 26, wherein each bit in the bitmap corresponds to a resource from a set of resources associated with the reference signal or wherein the value corresponds to the resource from the set of resources associated with the reference signal.

Example 28 is the method of example 27, further comprising: transmitting, to the UE, a configuration indicating the set of resources of the reference signal and a corresponding set of antenna ports for each resource in the set of resources, wherein the reduced number of antenna ports is based on a number of antenna ports in the corresponding set of antenna ports for the resource indicated in the bitmap or the resource indicated by the value in the DCI message.

Example 29 is the method of example 27, further comprising: transmitting, to the UE, a second reference signal and a configuration indicating the set of resources of the reference signal and a number of antenna ports for each resource in the set of resources.

Example 30 is the method of example 26, wherein each bit in the bitmap corresponds to a resource from a plurality of sets of resources associated with the reference signal or wherein the value corresponds to the resource from the plurality of sets of resources associated with the reference signal.

Example 31 is the method of example 30, further comprising: transmitting, to the UE, a configuration indicating the plurality of sets of resources of the reference signal and a corresponding set of antenna ports for each resource in each set of resources from the plurality of sets of resources, wherein the reduced number of antenna ports is based on a number of antenna ports in the corresponding set of antenna ports for the respective resource in the set of resources indicated in the bitmap or the DCI message.

Example 32 is the method of example 30, further comprising: transmitting, to the UE, a second reference signal and a configuration indicating the plurality of sets of resources of the reference signal.

Example 33 is the method of example 27, wherein the reference signal is a sounding reference signal (SRS).

Example 34 is the method of example 27, wherein the value is a SRS resource indicator (SRI) value indicated in the DCI message.

Example 35 is the method of example 27, wherein the reduced number of antenna ports are mapped to a set of preconfigured or defined port identifiers.

Example 36 is the method of example 26, wherein a resource of the reference signal is associated with a plurality of antenna ports of the apparatus equal to the number of antenna, and wherein the same resource is associated with the reduced number of antenna ports.

Example 37 is the method of example 36, further comprising: transmitting, to the UE, a second reference signal.

Example 38 is the method of example 36, further comprising: transmitting, to the UE, a set of antenna port identifiers via the bitmap in the MAC CE message, wherein each bit in a set of bits in the bitmap corresponds to a respective antenna port identifier in the set of antenna port identifiers.

Example 39 is the method of example 36, further comprising: transmitting, from the network entity, a set of antenna port identifiers via a field or a set of reserved bits in the DCI message.

Example 40 is the method of any examples of 23-39, further comprising: receiving, from the network entity, a capability report indicating the UE capability to increase a transmit power per antenna port of the reduced number of antenna ports.

Example 41 is the method of any examples of 23-40, wherein the TPMI is associated with a precoding matrix in at least one precoding matrix table which includes matrices associated with different numbers of antenna ports.

Example 42 is the method of example 41, wherein the precoding matrix is associated with the reduced number of antenna ports.

Example 43 is an apparatus for wireless communications, comprising means for performing a method in accordance with any one of examples 1-22.

Example 44 is an apparatus for wireless communications, comprising means for performing a method in accordance with any one of examples 23-42.

Example 45 is a non-transitory computer-readable medium comprising instructions that, when executed by an apparatus, causes the apparatus to perform a method in accordance with any one of examples 1-22.

Example 46 is a non-transitory computer-readable medium comprising instructions that, when executed by an apparatus, cause the apparatus to perform a method in accordance with any one of examples 23-42.

Example 47 is an apparatus for wireless communications, comprising: a memory comprising instructions; and one or more processors configured to execute the instructions to canse the apparatus to perform a method in accordance with any one of examples 1-22.

Example 48 is apparatus for wireless communications, comprising: a memory comprising instructions; and one or more processors configured to execute the instructions to cause the apparatus to perform a method in accordance with any one of examples 23-42.

1. An apparatus for wireless communication, comprising:
a processor;
a memory coupled with the processor; and
instructions stored in the memory, when executed by the processor, cause the apparatus to:
receive, from a network entity, an indication to reduce a number of antenna ports associated with uplink precoding;
transmit, to the network entity, a reference signal using the reduced number of antenna ports; and
receive, from the network entity, a message indicating a Transmit Precoder Matrix Indicator (TPMI) associated with the reduced number of antenna ports.

2. The apparatus of claim 1, wherein the indication is received via a Radio Resource Control (RRC) message.

3. The apparatus of claim 2, wherein the indication associates the reference signal with a set of antenna ports and the reduced number of antenna ports is based on a number of antenna ports in the set of antenna ports.

4. The apparatus of claim 1, wherein the indication is received via a bitmap in a medium access control (MAC) control element (CE) message, or wherein the indication is received via a value in a downlink control information (DCI) message.

5. The apparatus of claim 4, wherein each bit in the bitmap corresponds to a resource from a set of resources associated with the reference signal or wherein the value corresponds to the resource from the set of resources associated with the reference signal.

6. The apparatus of claim 5, wherein the instructions, when executed by the processor, further cause the apparatus to:
receive, from the network entity, a configuration indicating the set of resources of the reference signal and a corresponding set of antenna ports for each resource in the set of resources, wherein the reduced number of antenna ports is based on a number of antenna ports in the corresponding set of antenna ports for the resource indicated in the bitmap or the resource indicated by the value in the DCI message.

7. The apparatus of claim 5, wherein the instructions, when executed by the processor, further cause the apparatus to:
receive, from the network entity, a second reference signal and a configuration indicating the set of resources of the reference signal and a number of antenna ports for each resource in the set of resources;
measure one or more channel metrics for the second reference signal; and map, based on the one or more channel metrics and the number of antenna ports, the resource that is either indicated in the bitmap or indicated by the value in the DCI message to a set of antenna port identifiers,
wherein the reduced number of antenna ports is based on the set of antenna port identifiers.

8. The apparatus of claim 4, wherein each bit in the bitmap corresponds to a resource from a plurality of sets of resources associated with the reference signal or wherein the value corresponds to the resource from the plurality of sets of resources associated with the reference signal.

9. The apparatus of claim 8, wherein the instructions, when executed by the processor, further cause to: the apparatus
receive, from the network entity, a configuration indicating the plurality of sets of resources of the reference signal and a corresponding set of antenna ports for each resource in each set of resources from the plurality of sets of resources, wherein the reduced number of antenna ports is based on a number of antenna ports in the corresponding set of antenna ports for the respective resource in the set of resources indicated in the bitmap or the DCI message.

10. The apparatus of claim 8, wherein the instructions, when executed by the processor, further cause the apparatus to:
receive, from the network entity, a second reference signal and a configuration indicating the plurality of sets of resources of the reference signal;
measure one or more channel metrics for the second reference signal; and
map, based on the one or more channel metrics and the number of antenna ports, the respective resource in the set of resources that is indicated in the bitmap or the DCI message to a set of antenna port identifiers,
wherein the reduced number of antenna ports is based on the set of antenna port identifiers.

11. The apparatus of claim 5, wherein the reference signal is a sounding reference signal (SRS).

12. The apparatus of claim 5, wherein the value is a SRS resource indicator (SRI) value indicated in the DCI message.

13. The apparatus of claim 5, wherein the reduced number of antenna ports are mapped to a set of preconfigured or defined port identifiers.

14. The apparatus of claim 4, wherein a resource of the reference signal is associated with a plurality of antenna ports of the apparatus equal to the number of antenna, and wherein the same resource is associated with the reduced number of antenna ports.

15. The apparatus of claim 14, wherein the instructions, when executed by the processor, further cause the apparatus to:
receive, from the network entity, a second reference signal; measure one or more channel metrics for the second reference signal; and
map, based on the one or more channel metrics and the reduced number of antenna ports, the resource to a set of antenna port identifiers.

16. An apparatus for wireless communication, comprising:
a processor;
a memory coupled with the processor; and
instructions stored in the memory, when executed by the processor, cause the apparatus to:
transmit, to a User Equipment (UE), an indication to reduce a number of antenna ports associated with uplink precoding;
receive, from the UE, a reference signal using the reduced number of antenna ports; and
transmit, to the UE, a message indicating a Transmit Precoder Matrix Indicator (TPMI) associated with the reduced number of antenna ports.

17. The apparatus of claim 16, wherein the indication is transmitted via a Radio Resource Control (RRC) message.

18. The apparatus of claim 17, wherein the indication associates the reference signal with a set of antenna ports and the reduced number of antenna ports is based on a number of antenna ports in the set of antenna ports.

19. The apparatus of claim 16, wherein the indication is transmitted via a bitmap in a medium access control (MAC) control element (CE) message, or wherein the indication is transmitted via a value in a downlink control information (DCI) message.

20. The apparatus of claim 19, wherein each bit in the bitmap corresponds to a resource from a set of resources associated with the reference signal or wherein the value corresponds to the resource from the set of resources associated with the reference signal.

21-30. (canceled)
